(19) United States
(12) Patent Application Publication
(10) Pub. No.: US 2018/0068573 A1
(43) Pub. Date: Mar. 8, 2018

(54) MINDLESS TECHNOLOGIES TO SUBTLY INFLUENCE BEHAVIOR

(71) Applicant: Cornell University, Ithaca, NY (US)

(72) Inventors: Jean Marcel dos Reis Costa, Ithaca, NY (US); Alexander Travis Adams, Ithaca, NY (US); Tanzeem Choudhury, Ithaca, NY (US); Malte F. Jung, Ithaca, NY (US)

(21) Appl. No.: 15/698,564

(22) Filed: Sep. 7, 2017

Related U.S. Application Data
(60) Provisional application No. 62/384,586, filed on Sep. 7, 2016.

(51) Int. Cl. G09B 5/00; G09B 5/06; G09B 19/00

(52) U.S. Cl. CPC G09B 5/00; H04B 1/385; G09B 19/0092; G09B 5/06

(57) ABSTRACT

Persuasive technologies aim to influence user's behaviors. In order to be effective, many of the persuasive technologies developed so far relies on user's motivation and ability, which is highly variable and often the reason behind the failure of such technology. Mindless Computing, a new approach to persuasive technology design, is presented. Mindless Computing leverages theories and concepts from psychology and behavioral economics into the design of technologies for behavior change. Most of the current persuasive technologies do not utilize the fast and automatic mental processes for behavioral change and there is an opportunity for persuasive technology designers to develop systems that are less reliant on user's motivation and ability.

### STATEMENT REGARDING FEDERALLY SPONSORED RESEARCH OR DEVELOPMENT

This invention was made with government support under grant F538308 awarded by the Intelligence Advanced Research Projects Activity (IARPA), along with grant F538339, awarded by the National Science Foundation (NSF). The government has certain rights in the invention.

### TECHNICAL FIELD

This patent document relates to systems, devices, and processes that use technologies to subtly influence the behavior of a user without requiring conscious awareness.

### BACKGROUND

Persuasive technology is a rapidly evolving area of ubiquitous and wearable computing and is growing in popularity among various research groups. Designers of persuasive technologies use different design strategies in order to persuade users. In order to be effective, many of the persuasive technologies developed so far rely on user's motivation and ability, which is highly variable and often the reason behind the failure of such technology.

### SUMMARY

Techniques, systems, and devices are disclosed for designing a system that can influence a user's subconscious mind in order to change the user's behavior.

In one exemplary aspect, a method for influencing a user's perception of a subject is disclosed. The method includes obtaining a desired value associated with a sensory trigger, wherein the sensory trigger is relevant to the perception of the subject by the user and is configured to target an automatic mind of the user; obtaining, through one or more sensors, a first value associated the sensory trigger from the user; producing a second value, based on a comparison of the desired value and the first value, by a microcontroller, wherein the microcontroller is coupled with the one or more sensors to receive the desired value and the first value; and applying the second value to the user via a feedback interface coupled to the microcontroller to stimulate a subconscious response that influences the perception of the subject to the user.

In some embodiments, the method also includes obtaining, through the one or more sensors, one or more additional values that are associated with the sensory trigger, and producing the second value based on a comparison of the desired value, the first value, and one or more additional values.

In some embodiments, the sensory trigger includes a visual trigger, an auditory trigger, a gustatory trigger, an olfactory trigger, and a tactile trigger. In some embodiments, the sensory trigger further includes a vestibular trigger, a kinesthetic trigger, a trigger for thermoception, and a trigger for nociception.

In some embodiments, the one or more sensors include at least one color sensor and at least one force sensor. In some implementations, the one or more sensors include at least one audio sensor. In some embodiments, the one or more sensors include at least one haptic sensor.

In some embodiments, the feedback interface includes a visual feedback interface. In some implementations, the feedback interface includes an auditory feedback interface. For example, the auditory feedback interface is a headphone. In some implementations, the feedback interface includes a haptic feedback interface. For example, the feedback interface comprises a plurality of vibration motors.

In another exemplary aspect, a system for influencing a user's perception of a subject is disclosed. The system includes an input interface for obtaining a desired value associated with a sensory trigger, wherein the sensory trigger is relevant to the perception of the subject by the user and is configured to target an automatic mind of the user, a sensor for obtaining a first value associated the sensory trigger from the user; a microcontroller coupled to the sensor for producing a second value based on a comparison of the desired value and the first value, wherein the second value is different from the first value; and a feedback interface coupled to the microcontroller for applying the second value to the user to stimulate a subconscious response that influences the perception of the subject to the user.

In some embodiments, the system also includes one or more additional sensors for obtaining one or more additional values that are associated with the sensory trigger. In some implementations, the sensor and the one or more additional sensors include at least one color sensor and at least one force sensor. For example, the sensor is an audio sensor. The sensor may be a haptic sensor.

In some embodiments, the feedback interface includes a visual feedback interface. In some implementations, the feedback interface includes an auditory feedback interface. For example, the auditory feedback interface is a headphone. In some embodiments, the feedback interface includes a haptic feedback interface. For example, the haptic feedback interface comprises a plurality of vibration motors.

In another exemplary aspect, a device for influencing a user's perception of an amount of food held by the device is disclosed. The device includes a transparent plate; a color sensor coupled to a bottom of the transparent plate, the color sensor configured to sense a color of light from a top of the transparent plate; a force sensor positioned within the transparent plate configured to sense a weight of the food; a plurality of light emitting devices uniformly distributed below the transparent plate; and a microcontroller configured to adjust, based on the sensed color of light and the sensed weight of the food, the plurality of light emitting devices to change a perceived color of the transparent plate. In some embodiments, the transparent plate includes a diffused acrylic surface.

In another exemplary aspect, a system for influencing voice of a user is disclosed. The system includes a microphone configured to capture a first voice of the user; a processor; one or more memories configured to store instructions, when executed by the processor, causing the processor to produce a second voice by changing a feature of the first voice of the user; and a headphone to play the second voice to the user to influence the first voice of the user.

In some embodiments, the feature is a pitch of the voice. For example, the processor can be configured to change the pitch of the voice based on data stored a lookup table. The processor may also be configured to change the pitch of the voice to be 5% lower.

In another exemplary aspect, a device for influencing a user's perception of anxiety is disclosed. The device includes a silicone holder encompassing a microcontroller and a wireless communication module; a sensor coupled to the user configured to sense a heart rate of the user; a plurality of vibration motors attached to a bottom of the silicone holder, configured to apply a vibration to the user based on the sensed heart rate of the user, wherein the microcontroller is in communication with the plurality of vibration motors to control the vibration based on a signal received by the wireless communication; and a wrist band, coupled with the silicone holder and the plurality of vibration motors, configured to provide a stable connection between the plurality of vibration motors with the user. In some embodiments, the vibration is applied to the user at a frequency of 60 bpm.

### BRIEF DESCRIPTION OF THE DRAWINGS

FIG. 1 shows an exemplary arrangement of a mindless plate.

FIG. 2 shows a flowchart representation of an exemplary way to operate a mindless plate.

FIG. 3A shows an exemplary percentage of choices in both high and low contrast conditions.

FIG. 3B shows an exemplary percentage of selections in high and low contrast conditions for each of the different foods.

FIG. 4 shows a flowchart representation of the method of influencing a user's voices.

FIG. 5A shows an exemplary average change for both raised and lowered pitch conditions.

FIG. 5B shows exemplary change in pitch of each participant from the baseline for seven participants.

FIG. 6 shows an exemplary process model of emotion regulation.

FIG. 7 shows an exemplary embodiment of the EmotionCheck device.

FIG. 8 shows an exemplary diagram describing the components of the EmotionCheck device.

FIG. 9 is a flowchart representation of a method of influencing a user's anxiety level.

FIG. 10A shows an exemplary boxplot of anxiety changes (post-anxiety-pre-anxiety) in all groups.

FIG. 10B shows an exemplary interaction plot of the changes in the average anxiety scores.

FIG. 11 shows a flowchart representation of a method of influencing a user's perception of a subject.

FIG. 12 shows a flowchart representation of an exemplary process using mindless technologies.

### DETAILED DESCRIPTION

Persuasive technology is a rapidly evolving area of ubiquitous and wearable computing. Designers of persuasive technologies use different design strategies in order to persuade users, such as Foggs' seven types of persuasive strategies. However, a large part of the strategies used rely on conscious awareness of the user about the behavior to change. While this has been an effective way to develop persuasive technologies, there are several limitations and potential issues involved, such as the strong reliance on user's motivation and humans limited capacity for self-control. Many of the current persuasive technologies are heavily impacted by both internal factors and environmental contexts, such as what mood the user is in, where they are, how much stress they are under, or who they are with, which are unpredictable and subject to change. These internal factors can even disrupt people's interaction with the technologies, which may counteract positive aspects of the interventions.

The limitations of existing persuasive technologies bring up an important question: how can we develop persuasive technologies that are subtle and does not rely too much on people's motivation and ability to be effective? This patent document presents the concept of Mindless Computing, which is a new approach to persuasive technology design. Mindless refers to the automatic thoughts and behaviors that occur efficiently and without the need of conscious guidance or monitoring. Therefore, a Mindless Computing technology is defined as a mobile or ubiquitous, persuasive technology designed to subtly influence the behavior of users without requiring their conscious awareness.

The concept of Mindless Computing was from previous studies that show that human behaviors are controlled by two main cognitive systems; System 1 and System 2. System 1, also known as the “automatic mind”, is fast, automatic, and can occur subconsciously. System 2, which is also called as the “reflective mind”, is slow, conscious, and operate in a controlled fashion. The central idea is to design technologies taking into account the automatic mind (System 1). Behavior change based on the automatic mind has been studied in several research domains, including psychology and behavioral economics. Researchers have developed theories and demonstrated techniques in which a subtle change in behavior can occur while the user is unaware that the behavior had changed. Therefore, the goal is to identify behavior change strategies that rely on the automatic mind and show how to incorporate these strategies in the design of mobile and ubiquitous technology for behavior change.

Section headings are used in the present document only to improve readability, and do not in any way limit the scope of the disclosed technology.

Theories of Automatic Behavior

Automatic Mind and Reflective Mind

There is a set of theories called dual process theories that divide the mental processes underlying behavior into two categories. By leveraging previous studies on heuristics and biases, Kahneman presented a generalized dual-process theory that distinguishes two kinds of mental processes: System 1 and System 2. System 1 is characterized as fast, parallel, automatic, and require little or no effort, while System 2 is described as slow, serial, effortful, and operates in a controlled fashion. When individuals are thinking about a decision to take, such as whether or not to go to the gym or to eat healthy food, they are using System 2. When individuals make a “disgust face” when seeing moldy food or when they orient to the source of a sudden sound they are using System 1. Both systems are always active and interacting with each other. System 1 is always providing suggestions for System 2, including impressions, feelings and intuitions, and in most situations System 2 adopts the suggestions of System 1 with little or no modification.

Among the dual-process theories, two of the most prominent are the elaboration likelihood model (ELM) and the heuristic systematic model (HSM). The essence of these models concerns the conditions in which different aspects of a message influences the persuasion. In the ELM there are two major routes for persuasion: the central route and the peripheral route. Under the central route, persuasion will likely result from a person's careful consideration of the information presented, while under the peripheral route persuasion results from a limited examination of the information available or by the use of heuristics and other types of shortcuts. The HSM model is very similar to the ELM, also containing two basic persuasion processes that influence individual's judgments and behavior: the systematic processing and the heuristic processing. One concept of the model is the Sufficiency Principle, that states that people are partially guided by the “principle of least effort,” in which in some situations the mind processes information with the least amount of effort (heuristic), and in other situations it would use more effortful processing (systematic). Both in ELM and HSM the assumption is that people do not have the requisite knowledge, time, or opportunity to thoughtfully think about everything, so the use of System 1 helps to save people's energy, time, and mental effort.

Nudging

One concept that can leverage both System 1 and System 2 to influence people's behavior is nudging. Thaler and Sunstein define the concept as “any aspect of the choice architecture that alters people's behavior in a predictable way without forbidding any options or significantly changing their economic incentives.” A simple example is a cafeteria manager that replaces cake with fruit in the impulse basket next to the cash register aiming to encourage customers to buy more fruit and less cake. The customers still have the option of buying cake if they want, but the way that the choices are offered subtly influence them to pick more the fruit than the cake.

The idea of nudging has been applied in various contexts. For instance, in order to influence drivers to reduce the car speed, some cities used different nudges in the road design, including 3D paintings of kids chasing balls and lines painted across the road in a way that makes drivers think that they are driving faster than they actually are. This last approach has been successfully applied by the Chicago's Department of Transportation, since in the six months after the lines were painted there were 36% fewer crashes than the six-month period the year before.

The theory of Nudge was developed from previous studies that show that we can commit mistakes and act against our own interests without realizing that. A common example is the bandwagon effect, in which a person decides to do something just because many others are also doing it, regardless of her own beliefs. Another example is the size of the plate where we put our food, which can influence how much we eat. According to Kahneman, many of our mistakes and ‘irrational’ decisions can be explained by the way that our automatic mind (System 1) works.

Even though the System 1 saves our energy, time and mental effort, it can also lead us to jump into conclusions and take decisions without thinking. However, it is possible to use the way that the automatic mind works in our favor, by using nudges to influence behavior in a positive direction. The intervention of a mindless technology relies specifically on the automatic mind. As compared to a nudge, which can be a simple and static object, such as a sticker in the form of a foot to lead pedestrians in a certain direction, a mindless technology always involves some level of computing, which allows more robust, intelligent, and personalized interventions. Furthermore, designers of nudges have traditionally focused on changing features of the environment for group-level interventions rather than personal-level interventions. This can be, for instance, the impulse basket in a cafeteria (to influence customers to eat fruits) or the painted lines in a road (to influence drivers to slow down). A mindless technology, on the other hand, can be not only a feature of the environment but also an object that change the way a person perceives the environment. By presenting certain stimuli to the user (visual, auditory, tactile or olfactory), the technology can influence the way the user experiences their activities, which in turn can trigger automatic behavioral responses.

Subliminal Stimuli

One way of triggering fast and automatic responses (System 1) in individuals is by using subliminal stimuli. Researchers have been evaluating the impact of subliminal stimuli on people's behavior and emotion for a long time. A stimulus is called subliminal when it is below the threshold of conscious awareness, and it can be provided in different ways to participants. With visual stimuli, researchers often prime participants with specific images and determine if the images elicit different responses. For the auditory stimuli, one common method used is masking, in which the target auditory stimulus is hidden in some way.

There is quite a bit of evidence that subliminal stimuli can affect behavior. These effects have been observed on a variety of behaviors, including social cooperation, competitiveness and memory retrieval. For example, Wheeler and colleagues found that priming the African American stereotype led participants to perform poorly in a standardized test, compared to control groups. In another study, researchers found that older adults perform better on memory tests after subliminal exposure to words related to wisdom rather than senility.

The idea of subliminal stimuli has also been explored in the field of Human Computer Interaction (HCl). In this case, the focus has been mostly on alleviating the cognitive load associated with interacting with varied devices. The idea is to provide subliminal cues that allow users to receive additional information even when there is no capacity left for information transmission in a traditional way. Examples of research include a just-in-time memory support using subliminal cues delivered in a head-mounted display and one aid for visual search tasks. HCl Researchers have also investigated how subliminal cues can influence people's choices. For instance, the authors used subliminal cues to influence the selection of items in a virtual refrigerator.

Mindless Computing may use subliminal stimuli to trigger behavior change subconsciously. However, there are many other ways to accomplish this. It is possible to influence the user's behavior by providing a subtle but perceptible stimulus.

Systematic Review of Persuasive Technologies

Researchers and designers have combined different strategies to build technologies to influence people's attitude and behavior—such technologies are referred to as persuasive technologies. Persuasive technologies can be designed to influence diverse behaviors, such as to practice physical activities and to keep more sustainable habits.

Since people's behaviors are influenced by the automatic mind (System 1) and the reflective mind (System 2), one question that arises is: how many persuasive technologies rely on strategies that require conscious awareness of the user (System 2) to be effective? In order to investigate this question, a systematic review of papers describing persuasive technologies is performed. Attention has been focused in four conferences: Ubicomp, CHI, PervasiveHealth and Persuasive. The papers of these conferences are available in three electronic bases: ACM Digital Library. IEEE Explore and Springer. In order to find relevant papers in these electronic bases, the following keywords are used: persuasive technology, captology, behavior change, nudge, nudging, subliminal, subconscious, behavioral economics, and priming. Since the Persuasive conference is focused on persuasive technologies, instead of using keywords in the search all papers published in this conference since its inception (2006) until 2015 have also been reviewed. Once the articles had been obtained, all titles were reviewed and duplicates were removed. This phase yielded a result of 885 articles and formed the basis for the next step in the selection process.

The abstract of all articles identified in the first phase were obtained, with the following exclusion criteria: i) exclude if the paper does not present a persuasive technology; ii) exclude if the paper does not present a mobile or ubiquitous technology; iii) exclude if the paper does not present an evaluation of the technology or the intervention. A review process further reduced the number of articles to 252. The full text for all 252 papers was obtained and all the papers were reviewed with the same criteria for exclusion in mind. The final number of papers selected for the review was 176. The 176 papers were classified according to the kind of System (1 or 2) the technology acts upon. Among these papers, 165 papers describe persuasive technologies that were designed to focus on the rational mind (System 2) and only eleven papers present technologies that focus on the automatic mind (System 1).

System 2 Technologies

The results of the systematic review show that most of the persuasive technologies were designed to act upon the reflective and rational mind (System 2). One common characteristic of the technologies is the reliance on the motivation and/or ability of the users, so they require conscious attention and effort from individuals to change their behaviors.

Designers of persuasive technologies that focus on System 2 often leverage existing theories and models, both to make decisions about which features to implement and also to decide how to implement such functionality. Among the theoretical models used, one of the most popular is the Transtheoretical Model (TTM). The model assesses an individual's readiness to act on a new healthier behavior, and provides strategies to guide the individual through stages of change. It has been used to encourage diverse behaviors, such as to practice physical activities and to make healthier meal choices.

Another common theory leveraged in the design of persuasive technologies that act upon System 2 is Goal-Setting Theory, which suggests that two dimensions of goals influence performance: difficulty and specificity. According to the theory, the best performance should be achieved by focusing on specific and challenging goals, yet the goals should be realistic to achieve. Several technologies were designed using this theory, including tools to help people reduce their stress levels and to increase their physical activities.

In addition to behavioral theories and models, researchers have used different strategies to persuade the users. Among the strategies used, some of the most popular are the seven persuasive strategies presented by BJ Fogg: Reduction, Tunneling. Self-monitoring. Conditioning, Surveillance. Tailoring and Suggestion.

One of the most used persuasion strategies is self-monitoring. Commercial and research applications have incorporated automated sensing or manual tracking features that allow users to monitor their activities and potentially make changes based on that. These applications offer different ways of presenting feedback. In UbiFit, for instance, the wallpaper of the mobile phone shows abstract representations that change based on the user's activities, encouraging the user to reflect about his lifestyle.

Another common strategy used in persuasive technologies is conditioning, which is usually achieved by providing positive or negative reinforcement. One example of application using this strategy is Fish'n'Steps, in which the growth and activity of a virtual fish is linked to the daily step count of the user. The feedback is provided with a fish happy and growing (positive reinforcement) or crying and not growing (negative reinforcement).

System 1 Technologies

The result of the systematic review shows that only eleven of the 176 papers describe persuasive technologies designed to focus on the automatic mind (System 1). Furthermore, only two papers explicitly mention behavioral theories that inspired the design of the technology. In Rogers et al., the authors present an ambient installation that influences people to take the stairs instead of the elevator. The work was inspired by previous studies that show how fast and frugal heuristics can influence people's behavior. In Lee et al., the authors evaluated persuasive technologies to influence healthy eating. In their work, they showed how to leverage behavioral economics approaches in the design of persuasive technologies.

The System 1 technologies found in the review were designed to influence different kinds of behavior, including: decrease energy consumption, practice physical activities, improve behavior during social interactions, keep proper posture while sitting, look at a shop window, eat healthy snacks, drink water, and correct bad posture while playing violin.

Among the approaches used in the persuasive technologies that focus on System 1, the most common is to change aspects of the environment. Eight out of the eleven papers found use this approach. All technologies described in these papers use visual cues in the environment to influence people's behavior. One approach used in papers that focus on energy consumption is to use pre-existing color associations and change the colors of the environment to trigger different perceptions and sensations. Another approach used is to deploy ambient installations that are playful and attractive in order to lure individuals to take the stairs more than the elevator, to drink in a water fountain, and to look at a shop window. Other researchers used subtle feedback that act in the periphery of the user's attention.

Another approach used in the persuasive technologies found is to use mobile technologies. In Rajan et al., the authors used audible cues to reduce dominance in collaborative tasks. In Lee et al., the authors used a robot that influences people to make healthier snack choices by making the choices more accessible and convenient. Finally, in Van Der Linden et al., the researchers present a technology that provides a gentle vibrotactile feedback to help people correct bad posture while playing violin.

Issues with the Focus on System 2

While persuasive technologies drawing from System 2 (slow) processes have achieved enormous success, there are limitations stemming from that sole focus on System 2. In this section we describe some issues with the reliance on System 2 that can compromise the effectiveness of persuasive technologies.

Reliance on User's Motivation and Ability

BJ Fogg argued that there are three reasons that restrain individuals from performing a target behavior: i) lack of motivation; ii) lack of ability; and iii) lack of a well-timed trigger to perform the behavior. For example, a woman can be motivated to lose weight after hearing jokes from others (trigger), but without knowing how to lose weight (lack of ability) she may have problems to achieve her goal.

Several persuasive technologies were created based on this assumption that users need to have motivation, ability and a trigger to change their behaviors. Because of that, whenever a technology does not affect people's behaviors as expected, the researchers often argue that users did not have the ability or were not motivated enough. For instance, previous studies stated that wireless fitness trackers tend to result in only short-term adoption and changes in behavior, and one common explanation is that users lose motivation over time.

Even though motivation and ability are important factors in influencing behavior, previous studies showed that individuals can also change their behaviors without being aware of it. Therefore, the argument that individuals need to be motivated and have the ability to perform a behavior only holds with persuasive technologies that rely on System 2 to work properly.

Since persuasive technologies that rely on System 2 put a lot of burden on the user, the behavior change is often expected to be a long-term process. One of the reasons is that many behaviors are part of people's daily lives, so a single change often requires individuals to change their routines, which is not an easy task. Furthermore, the literature shows that the human capacity for self-control is limited, so behavior change setbacks can always occur, especially in situations where self-control resources are drained by demands in other areas of one's life, such as when individuals are stressed, in bad mood, or distracted with many tasks. This is why several researchers advocate that in order to evaluate health behavior change it is necessary to conduct a longitudinal study over several months or even years, since it takes a long time for a behavior change to truly stick.

Feedback and Impact on Performance

In many circumstances it is important to keep the focus on long-term behavior change, since the goal of the person is not something that can be achieved in one single activity. For instance, a user that uses a fitness tracking device with the goal of losing weight will reach his goal only if he starts to practice physical activities regularly. However, there are situations in which a single change of behavior can have major consequences for the individual. For instance, a driver that is persuaded to reduce the car speed can avoid an accident, and a person that adjusts their behavior during a business meeting can create a better first impression. In these situations a technology can provide feedback after the activity, but then it can be too late. These examples show how the timing of the feedback is an important aspect in behavior change technologies.

One aspect that has to be taken into account in the design of persuasive technologies is how to provide feedback without interrupting the user. This is when persuasive technologies based on System 2 can fail. Since System 2 processes involve conscious reasoning, users have to direct their attention to the technology when needed, which often involves pausing or stopping their current tasks. For instance, a common approach used in persuasive technologies is to present data about the user's behavior, so that he can reflect and change their behavior if needed. This approach requires the user to look and process the information presented, which may not be feasible in situations that the user is busy with other tasks.

The problem with this conscious interaction is that not all self-regulatory processes require conscious awareness and attention to operate smoothly, and a substantial portion of day-to-day behavior has been thought to occur automatically or mindlessly. In situations in which the performance of a task has become automatized, conscious thought about the task can impair the performance while performing it, which has been known as the “centipede effect” or “humphrey's law”. Baumeister, for example, argues that conscious attention to skilled manual performance can disrupt that performance. He shows that asking people to think about what their hands are doing makes them worse at a manual game, as does letting them know that they are being evaluated.

Mindless Computing

There are several issues involved in the reliance on the reflective and rational mind (System 2) in the design of persuasive technologies. However, the systematic review shows that most persuasive technologies were designed taking into account only the reflective mind. This strategy has been applied in different contexts and several studies have shown empirical evidence that this kind of technology can indeed persuade users. On the other hand, given the issues of System 2 technologies, a new approach for designing persuasive technologies is necessary. In order to bridge this gap. Mindless Computing, which is a new perspective for persuasive technology design, is presented. The main idea of Mindless Computing is to design persuasive technologies that can subtly influence users' behavior without requiring their conscious awareness.

Mindless technologies can fill some gaps in the design of persuasive technologies, by both subtly integrating itself into the daily lives of users and by influencing users' behavior requiring little effort and attention from them.

In order to demonstrate how behavior change technologies can be designed using System 1 processes, several embodiments of mindless technologies are presented. In one embodiment, a Mindless Plate is developed as a technology that leverages perception bias to create an illusion to subconsciously influence individuals perception of food portion size. In another embodiment, a mobile application can influence the way people speak by manipulating the pitch of their voice and playing it back to them in real-time.

These embodiments demonstrate how to develop mindless technologies, which leverage behavioral theories based on the automatic mind (System 1) in order to subtly influence people's behavior. It is important to note that the decision to start using a mindless technology is a conscious process (System 2). In some embodiments, the user has to make the decision to pick up and use the Mindless Plate or turn on the mobile phone application that manipulates the pitch of their voice in real-time. However, once the user starts to use the technology the behavior influence works in parallel with the user's activity, without interfering with their main task.

Mindless Plate

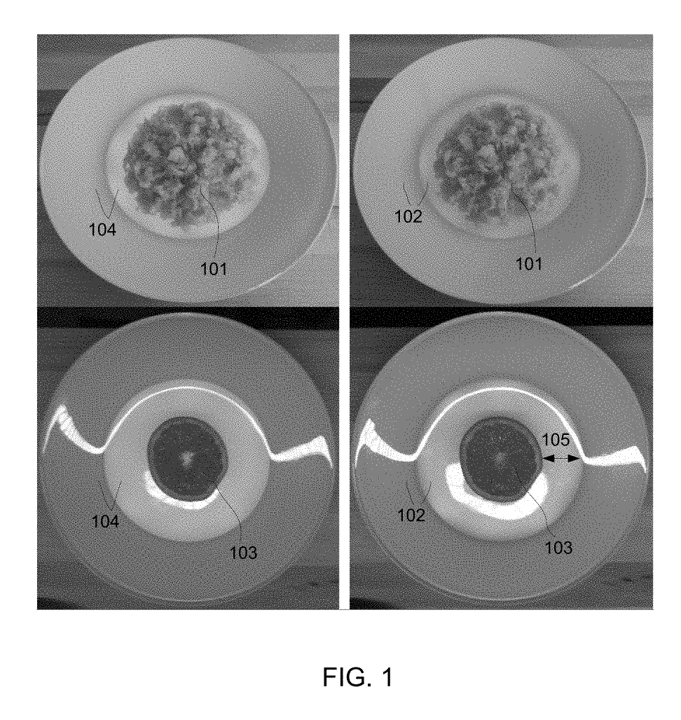

Mindless Computing technologies can leverage our most basic senses to instantaneously influence different aspects of our daily lives. Perception bias has been shown to be an effective medium for creating illusions, which can augment individual's perception of different attributes of an object such as size, color, and sound. The Mindless Plate, as shown in FIG. 1, is a Mindless Computing persuasive technology that leverages perception bias to subconsciously create the Delboeuf illusion of more food on a plate.

Background and Motivation

Food and branding research groups have leveraged the Delboeuf illusion to alter individual's perception of serving size, resulting in the individuals serving themselves smaller portions. One method is using smaller plates or serving utensils, which causes individuals to serve smaller portions of food. This is due to a perception bias that causes individuals to perceive that there is more food on the plate due to the amount of surface area covered or (in the case of serving utensils) that they have served more (expecting the same quantity that they would have with a larger utensil).

Food and behavioral researchers such as Van Ittersum and Wansink have shown that color bias can affect the perceived amount of food on a plate. This illusion is a result of being able to perceive the edges of the food in relationship to the plate. With low contrasts, the edges are harder to distinguish and are somewhat blurred, which can cause the illusion that the plate extends the actual food on the dish. With high contrasts in color, the edges of the food and gaps between pieces of food are much more clear, while with low contrast the edges are blurred and the gaps seem filled, as shown in FIG. 1. In FIG. 1, crushed pineapple 101 and a slice of an orange 103 are placed on a Mindless Plate. The Mindless Plate can show high contrast 102 (e.g., blue v. orange) and low contrasts 104 (e.g., blue v. blue) in color for the respective food items.

It is also shown that when the width of the rim is larger (105) and is a different color from the center of the plate, individuals perceive that the portion of food is larger than it actually is. This is due to the increased emphasis on the relationship between the outer circle (the plates rim) and inner circle, which increases the effects of the Delboeuf illusion.

The Mindless Plate System

The Mindless Plate works by sensing the color of the food that is served on the plate and changing the color of the inner circle of the plate accordingly. This allows for the plate to subconsciously influence users perception of the amount of food on the plate by leveraging the effect of the Delboeuf illusion.

In some embodiments, the Mindless Plate includes two or more sensors, several RGB LEDs (Model: WS2812S), a microcontroller (e.g., Teensy 3.1), and a digital potentiometer, all of which can be packaged into the form of a plate. The rim of the glass plate can be painted white, which helps enhance the effect of the Delboeuf illusion by increasing the contrast between the plate's rim and the inner circle, making the inner circle of the plate seem smaller. The sensors may include a force sensitive resistor (FSR) for sensing the weight of the food, and a color sensor (e.g., model: ISL29125) for capturing the color of the food.

The core of the Mindless plate may include several layers that lie under a glass plate and are enclosed in a plastic case. For example, the RGB LEDs can be attached along the side of an optically clear piece of mirrored acrylic which has been fractured across the top, in order to evenly distribute the light across the surface. The luminance (voltage) can be controlled via a 10K digital potentiometer. Two small air gaps may be placed (approximately 1.6 and 3.2 mm) on top of the acrylic with a sheet of light diffusing film placed between each. In some embodiments, the color sensor is attached to the bottom of the mirrored acrylic where a small, convex lens is milled into the acrylic, allowing the sensor to capture the light from across the top of the plate. In some implementations, the FSR is cut into the shape of a ring (approximately 152 mm inside diameter) and placed on the of the film. In some embodiments, a layer is positioned below the mirror acrylic to house the microcontroller (e.g., Teensy 3.1 w/Arm Cortex-M4 processor) and a battery (e.g., 2000 mAh polymer lithium ion).

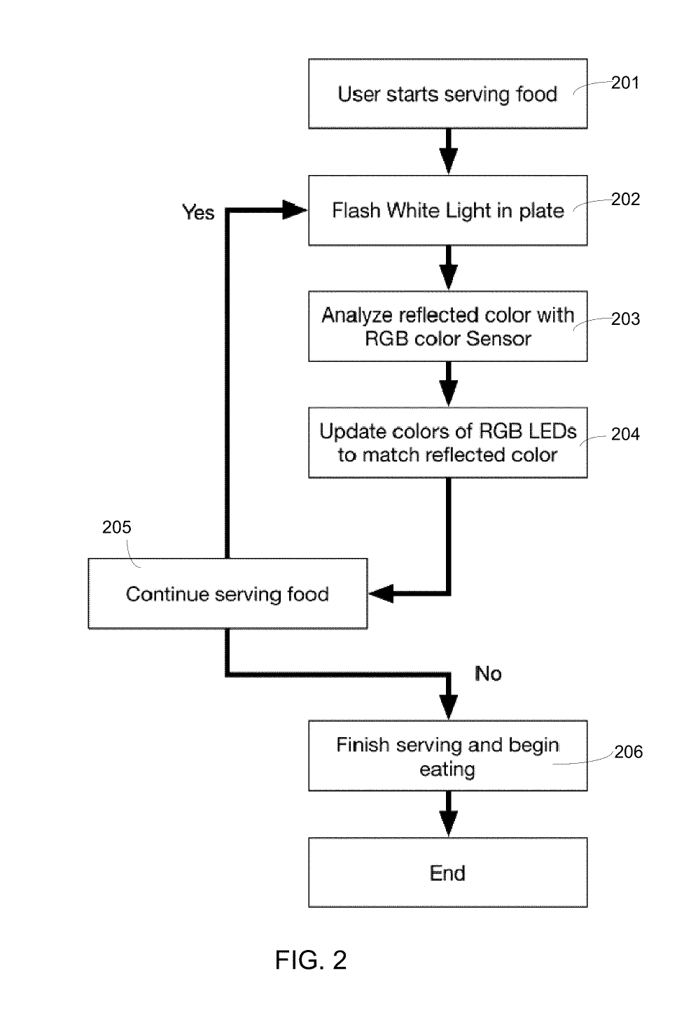

FIG. 2 shows a flowchart representation of an exemplary way to operate a mindless plate. A user starts serving food, at 201, to a mindless plate. The mindless plate first flashes white light at 202. The plate then, at 203, analyzes reflected color from the served food. Based on the analysis of the reflected color, the plate, at 204, updates colors of the LEDs to match (or contrast) the reflected color. The plate also detects, at 205, if the user is continually serving food to the plate using its weight sensor. If so, the plate continues to sense and adjust its LEDs based on the detected color of the food. When the user finishes serving and begins eating (206), the plate also stops its sensing and adjustment of colors.

In some embodiments, as the user serves food, the contrast between the color of the plate and food minimizes, creating a bias in the perceived size of the portion served. This perception bias makes the portion of food seem larger, as the edges and gaps in the food served are fill with similar color. This encourages the user that they have served themselves a larger portion than they have and satisfies their need to continue serving earlier than if the perceived portion size was smaller (as it would be with a high contrast in color between the food and plate).

In some embodiments, the color mapping is a direct RGB-to-RGB mapping from the color of the food to the color of the plate. In order to create a more natural look to the color of the plate, the plate can be edge-lit with a diffused acrylic surface. The acrylic can be diffused increasingly towards the center. This makes the color more uniform across the surface and eliminates hotspots around the individual LEDs.

Experiment Design

In order to evaluate the Mindless Plate, an experiment was designed to determine if participants (n=12, 3 female, 9 male) perception of portion size was biased when looking at food on two Mindless Plates (one of the plates in high contrast with the color of the plate and the other in low contrast). The plates were placed behind a blinder while an equal amount of food (both in weight and surface area) was placed on them. When ready, the blinder was lifted for few seconds and the participants were asked to look at the two plates (while standing up, looking down on the equally sized portions of food) and report which of the two had a larger portion of food on it. Participants were asked to do this seven times, each with a different type (and color) of food. The foods used were peas (green), kidney beans (burgundy), potato chips (yellow/brown), peanuts (light brown), carrots (orange), rice (white), and crushed pineapple (bright yellow). Participants were asked to choose which plate seemed to have a larger portion size, they were not allowed chose that the two portions were the same size. This was to encourage participants to allow their perception to influence their choice and make a more visceral decision.

In order to maintain consistency, the food was weighed between each user and a barrier (similar to a cookie cutter) was used to ensure that the surface area of each food was equal on the two plates. The different foods were shown in a random order for each participant and the placement of the low and high contrasts alternated between left and right between each food shown. Fine grain (or crumbled) foods were used to avoid participants being able to count the pieces of food. Foods that would not easily be arranged into equal distributions over the plates were crumbled using a pestle and mortar. Since the aim of the study was to test the participants perception of the portion size, the color sensing capabilities were disabled and the contrasts were manually configured to prevent any inconsistencies with the colors of the plate (such as a change in ambient light levels).

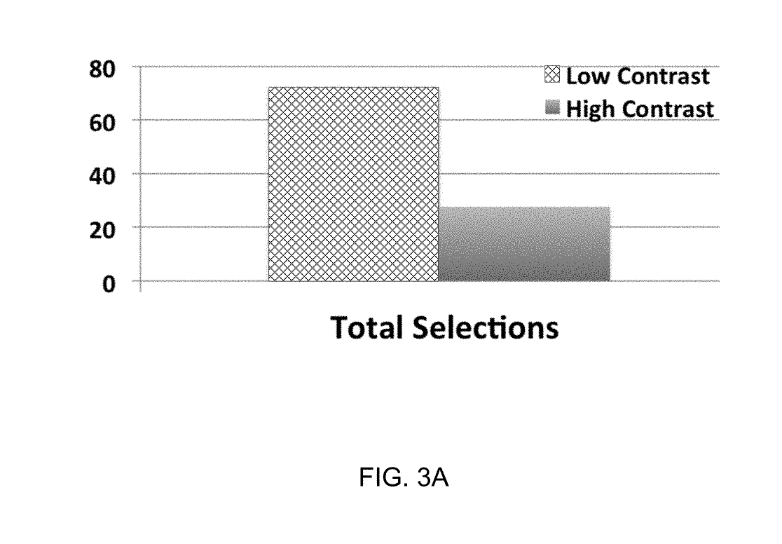

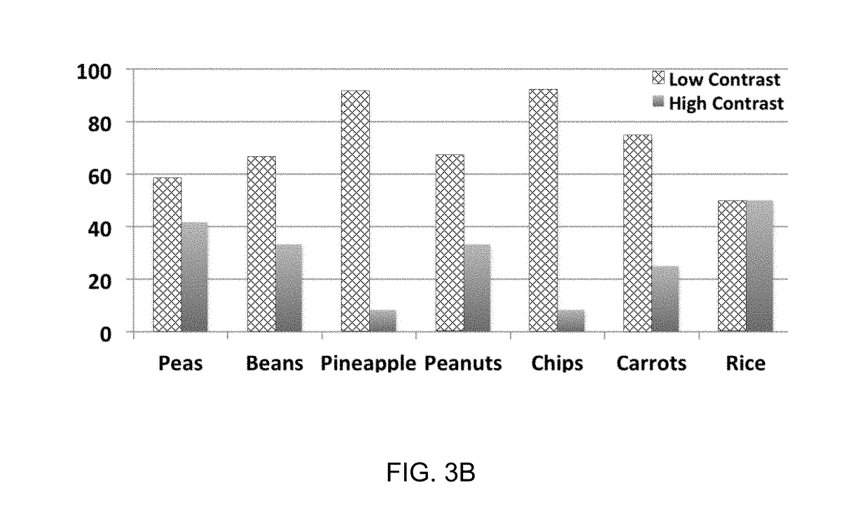

FIG. 3A shows the percentage of choices in both conditions (High and Low contrast) for all foods combined (probability of low contrast choice as measured by t-tests: p=0.0011). It was found that 73% of the foods chosen to be the larger portion had a low contrast in color with the plate they were on (p=0.0011 as measured by t-tests) as seen in FIG. 3A. FIG. 3B shows how the results were distributed across the different foods used in the experiment. The results from this study lead to the conclusion that the Mindless Plate system can leverage color contrast to create the illusion that one portion of food is larger than another equal portion. This illusion can be leveraged to bias the estimated portion size either to be larger (with low contrast) or smaller (with high contrast). These findings can be used in the design of a ubiquitous system that subconsciously influences users to serve themselves smaller portions of food.

The Mindless Plate can have a long term impact on how much food individuals consume on a daily basis. This is due to previous studies on the subconscious impact of illusions, dinnerware, and portion size. These studies have shown that even when individuals are aware of biases, the effect of the bias is only reduced temporarily. As individuals become less conscious of a bias, the subconscious effect of the bias increases, which can be due to repeated exposure to the bias causing them to pay less attention to it, external distractions that shift the user's focus away from the bias, or simply not knowing the bias is present.

Subconscious Influence on People's Voices

This embodiment shows that it is possible to influence people's voices by making them hear themselves with a pitch shifting as they speak. This process happens automatically and without people's awareness, so it shows how to leverage System 1 theories in the development of persuasive technologies.

Background and Motivation

Face-to-face communication plays a major role in our lives. A major part of the communication process is nonverbal language, which are the messages that we send beyond the words themselves, such as gestures, facial expressions, and voice pitch. These micro-level aspects of social skills are highly important in determining the outcomes of social interactions. However, our nonverbal behaviors are often performed unconsciously and automatically, so we can negatively affect our social interactions without realizing that. Among the nonverbal behaviors, the use of voice is one of the most important in impression formation. When we speak, people pay attention not only to what we say, but also how we say it, including aspects such as pitch, volume, and pace. For instance, people with lower-pitched voices are associated as more attractive, dominant and having more favorable personality traits. In fact, pitch can even influence voting behavior. Politicians know the importance of using their voices effectively, which is why many of them have voice-coaching.

In order to help people improve their nonverbal behaviors, researchers have developed different technological approaches. However, many solutions rely on feedback after the social interaction, which can be too late in some situations such as job interviews, business meetings and public speeches. Other approaches rely on traditional feedback in real-time, but previous studies found that if a person pays too much attention to their own behavior during a social interaction this can have detrimental effects on their performance. The question then is: how to design a technology that positively influence the nonverbal behavior of the user in real-time without compromising their performance?

With this question in mind a mobile application is developed to influence the way that the user speaks without requiring their conscious awareness. The design of the application was inspired by previous research that shows that speakers may change the pitch of their voices when they hear their voices played back with the pitch manipulated (either raised or lowered) over headphones. This effect has been tested in a laboratory environment and with subjects producing a small number of utterances, so it is valuable to see if the intervention is also effective in real social interactions. In some embodiments, a mobile technology can be developed to automatically influence several aspects of people's voices in real-time, including volume and pace. A person can use this system in situations in which she wants to create a good first impression, such as during a phone interview or public speech.

Description of the System

In some embodiments, an iPhone application can been developed to shift the pitch of the user as captured by the commodity microphone using Short Time Fourier Transform and immediately plays back to the user through an earphone. In order to shift the pitch, Apple's Accelerate Framework, an API that provides mathematical functions for signal processing may be used. Other equivalent APIs on other mobile platforms (e.g., Android) may also be used. Since the feedback should not distract the user, it was important to minimize the playback delay. To achieve this goal, the Fast Fourier Transform can be done over small frames, which allowed shifting the pitch and playing back to the user in less than 50 ms. With this minimal delay, the voice is seemingly played back in real-time and does not disrupt the speech flow of the user.

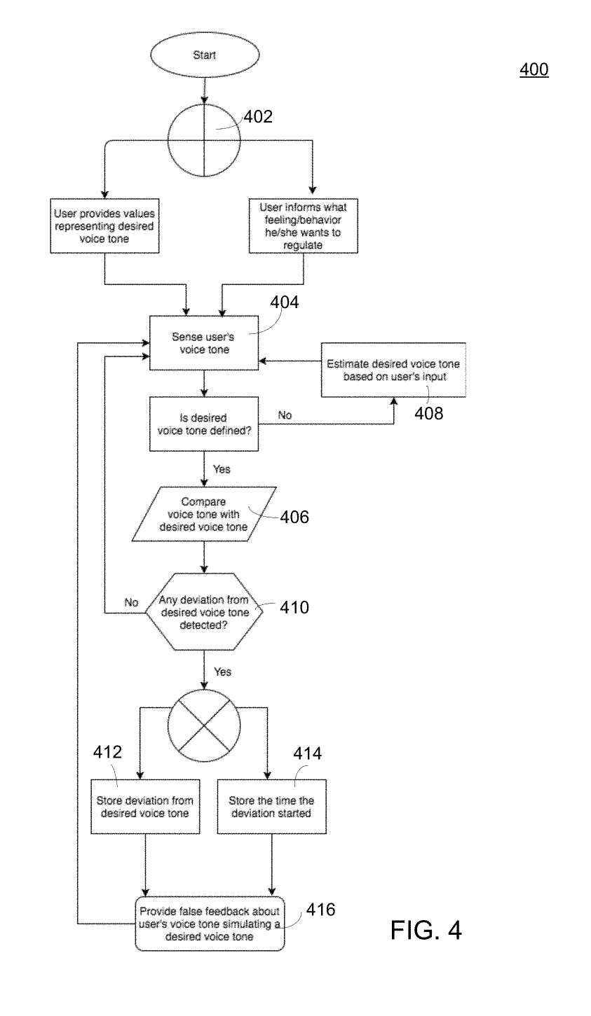

FIG. 4 shows a flowchart representation of the method 400 of influencing quality or some parameters of a user's voice. The method can be implemented on a mobile computing system, such as an iPhone or an Android phone. The method 400 includes receiving, at 402, inputs from the user by (1) values representing desired voice tone by the user, and/or (2) the type of feeling/behavior or voice quality that the user wants to regulate. The voice quality may for example include tone or pitch of the voice. The method 400 then includes sensing, at 404, the user's voice tone using one or more sensors. For example, the sensing can be performed using a microphone built in the mobile computing system. If a desired voice tone has been defined in step 402, the method 400 proceeds to compare, at 406, the sensed voice tone with the desired voice tone. On the other hand, if the desired voice tone is not yet defined, the method 400 includes estimating, at 408, the desired voice tone based on the user input regarding the type of feeling/behavior that he or she wants to regulate. In some embodiments, the desired tone of voice can be estimated based on the difference between the sensed tone and a target tone. For example, speakers with lower pitches in public presentations are often perceived as more confident. In such cases, a user's pitch may be adaptively altered by targeting the desired pitch to be lower (e.g., 5% lower) than the sensed pitch to gradually shift the tone of the speaker without making the change too drastic or noticeable. In some embodiments, the corresponding voice quality parameters include values or ranges of corresponding volume, pitch, or tone of the user's voice. For example, a look-up table may be stored at the mobile computing device to include entries for different voice tones and corresponding voice quality parameters. For example, the voice tone entries may be adjectives such as “angry” “calm” happy” and so on. The method 400 may access the look-up table to determine the desired voice tone. The method 400 then includes determining, at 410, if there is any deviation in the sensed voice tone from the desired voice tone. If yes, then the method 400 proceeds to store the deviation (412) and the time when the deviation starts (414). Finally, the method 400 includes providing, at 416, false feedback simulating a desired voice tone to the user. In some embodiments, the false feedback can be provided using a headphone or an earphone for the mobile computing system.

Experiment Design

Fourteen young adult participants (ages 18-27, 9 females and 4 males) participated in a study, all of which reported to be fluent in English and not having speech disorders or other issues with the vocal tract. The participants were instructed that they would participate of a study to understand how the use of technologies affects social interactions, and all tasks of the study would be audio-recorded. The experiment was conducted as follows.

First, the participants were taken to a sound-treated room where they sat down and were asked to read aloud a technical paper (for a duration of three minutes) as if they were reading it to someone else. While reading the paper, all participants had an earphone (model JVC HA-F140) only in their right ear. Half of the participants received frequency-altered feedback (FAF) through the earphones, while the other half did not receive any feedback. The volume of the feedback was kept low (20% of the maximum volume possible) so that the participants can still hear their own voices. The participants that received the FAF listened to themselves while their pitches were slightly shifted and played back as they were speaking, but they were informed that they were hearing their own voices. There were two different conditions for the pitch shifting. In one condition the participants listened to themselves with a pitch 5% lower than their current pitch (low pitch condition), while in the other condition the pitch was increased in 5% (high pitch condition). Since most people cannot perceive how their voices sound to others, the 5% change proved to be a good balance that afforded the participants to perceive their voice as natural while being enough of a change to subconsciously cause the participant to change their pitch.

After 3 minutes, the participants asked to reread the same text during 3 minutes, but this time the participants that received FAF did not receive feedback, while the others that did not receive feedback listened to themselves with the pitch shifting. The purpose of the reading task without feedback was to use it as a baseline to identify what is the average pitch of each participant, while the reading task with feedback was used to make people get used with the feedback.

After the reading tasks, the subjects were instructed that they would participate of a mock job interview through Google Hangout. The interview was conducted by a confederate located in a different room. The confederate asked 5 typical interview questions, which have been used in the past in another study. All participants were informed that they should answer the questions as they would in a real job interview, so they can provide information about themselves and their past experiences. During the interview, the participants received feedback of their voices with the same pitch shifting that they were exposed during one of the reading tasks.

Finally, the participants were asked to fill out a survey, containing questions asking how they thought they had performed in the interview, how they felt during and after the interview, and to what extent they were able to concentrate on the task.

In order to evaluate if and how much the participants pitch changed as a result of the manipulation, the audio recordings were analyzed using the software program Praat. The audio recording of each user was divided into three files: reading task with feedback, reading test without feedback (baseline), and job interview. Then, the software helps to obtain the mean pitch in Hertz of each baseline and the mean pitch in Hertz of each interview.

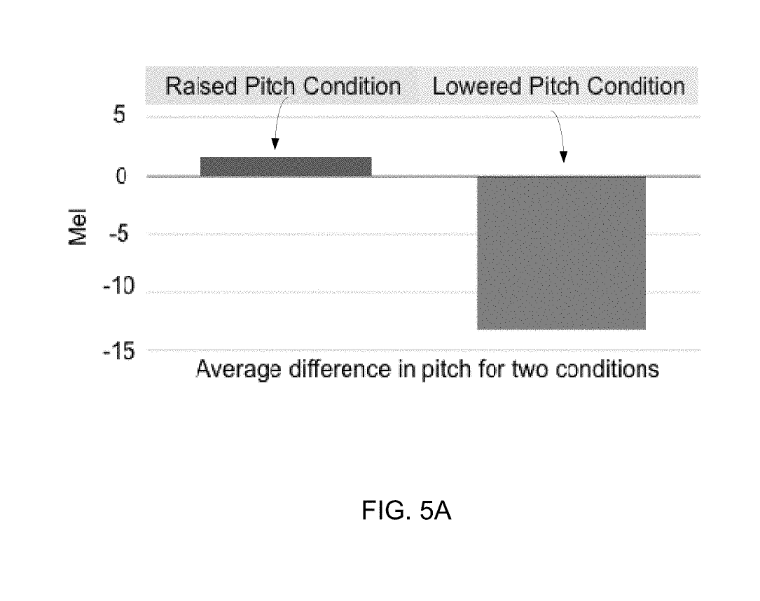

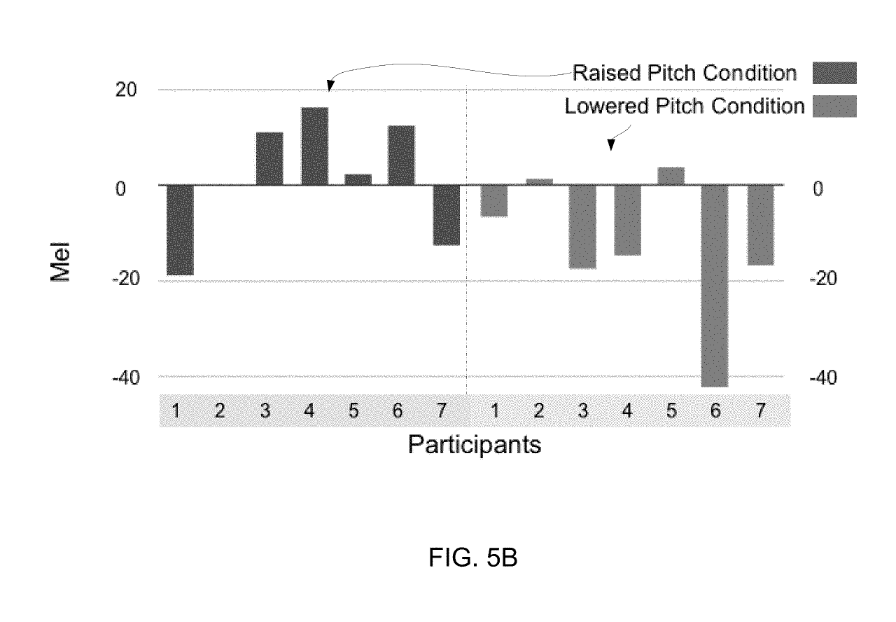

The major goal of this study was to identify if the mean pitch of each participant changed during the interview in relation to their baseline. In order to evaluate this, the mean pitch is first converted from Hz to Mel using Douglas O'Shaughnessy's conversion formula. By using the Mel Scale, a psychophysical scale for pitch, equal difference in perceived pitch can be seen according to human perception. As shown in FIG. 5A, which shows an exemplary average change for both raised and lowered pitch conditions, the average difference between the baseline and raised feedback condition for the participants was an increase in pitch by 1.6 Mel, and the difference between the baseline and lowered pitch feedback was a decrease in pitch by 13.34 Mel. The just-noticeable difference (JND) for pitch in complex tones, such as the human voice, under 607.5 Mel (500 Hz) is 1.6 Mel (1 Hz). This shows that both conditions did in fact show a noticeable difference in pitch change on average.

FIG. 5B shows exemplary change in pitch of each participant from the baseline for seven participants. As FIG. 5B indicates, not all participants were influenced as intended and one did not change pitch at all. In the lower pitch condition, 5 out of 7 participants lowered their voice pitches in relation to their baselines. The two remaining participants increased their voice pitches, but the changes were very small, one falling below the JND threshold (1.3 Mel, no perceivable change) while the other was above the JND threshold (0.3.8 Mel). In the high pitch condition, 4 out of 7 participants raised the pitch above the JND threshold while two lowered their pitch below the JND threshold and one showed no change.

The results of this study provide preliminary evidence that it is possible to influence people's pitch during social interactions and this can be a medium for developing Mindless Computing technologies that can potentially influence behavior to improve user's confidence while speaking. Since this is a preliminary investigation, it is difficult to tell if the direction of the pitch change will be the same in other conditions. However, the study showed that most participants changed the pitch of their voice during the job interview, and there is an interesting trend in which the pitch change is in the same direction of the manipulation. Some of these changes were large, such as the subject that lowered his pitch by 42.5 Mel. Even though people's mean pitch can vary, large changes like that often do not occur except if there are other factors influencing their speech.

EmotionCheck

Emotions powerfully shape how we interact with the world around us. Most of the time our emotions serve us very well. In other situations emotions can harm more than help, such as when an individual ‘freezes’ during a presentation or when a person is propelled to hit another during an episode of anger. In order to avoid these situations, we make efforts to regulate our emotions to make them helpful rather than harmful. These efforts through which we influence the emotions we have, when we have them, and how to experience and express these emotions is called “emotion regulation”. As we mature, we learn how to employ different strategies to effectively regulate our emotions. However, in many cases we are not able to regulate our emotions properly, which can negatively influence our mental health, relationship satisfaction, work performance and physical well-being.

Background and Motivation

The past years have seen enormous growth in research on emotion regulation. While research in psychology has focused mostly on understanding the phenomenon of emotion regulation and the impact that different emotion regulation strategies have on cognitive and affective processes, research in HCl and Ubicomp has focused on designing and developing technologies to help people regulate their emotions.

One popular theme in HCl and Ubicomp is the design and development of technologies for mood regulation, such as systems that focus on improving our awareness of our affective states. Although “mood” and “emotion” are used interchangeably, both in everyday language and in research, they refer to different experiential phenomena. While emotions are often elicited by specific events and trigger behavioral response tendencies relevant to these events, moods tend to last longer than emotions, for hours, days or weeks. Moods can be considered the “pervasive and sustained ‘emotional climate’”, while emotions are the “fluctuating changes in emotional ‘weather’”. Therefore, while technologies that focus on mood regulation can help individuals to improve their overall affective state, technologies for emotion regulation are designed to help users to manage their emotions as they unfold.

In order to help users to regulate their ongoing emotions, researchers devised different real-time interventions. Examples include biofeedback technologies that assist users in manipulating their affective states and just-in-time interventions that suggest activities for users to calm down. However, many of the current real-time interventions require a lot of attention and effort from the user, which may affect their concentration during ongoing tasks and even increase the user's stress. These issues can counteract the positive aspects of the technologies and negatively affect the desired outcome. Therefore, a question that arises is: how to design mobile interventions that can help users to regulate their emotions in real-time, without compromising their behavior or cognition?

It is possible to do that by developing mobile interventions that focus on implicit emotion regulation, in which users are able to regulate their emotions without the need for conscious supervision or explicit intentions. Previous work has shown that it is possible to develop behavior change technologies that can subtly influence user's behavior without requiring their conscious awareness. Researchers leveraged studies from psychology and behavioral economics to design interventions that can trigger automatic behavioral responses.

Developing technologies to help people regulate their moods and emotions includes mobile technologies to manage or relieve stress, virtual reality environments to induce positive emotions, robots to regulate negative emotions during conflict situations and mobile applications that help users to relax. In addition to technologies designed for the general population, some technologies have been developed for individuals with emotional disorders, such as depression and bipolar disorder.

A common strategy used by researchers and designers that develop technologies for mood and emotion regulation is the focus on reflection. Reflection on internal mental states can help users to better understand their responses to emotional situations, such as stressful tasks. One example of technology that focuses on reflection is Emotion Map, which is an app that helps users to improve their emotional self-knowledge by allowing them to log their emotions with the corresponding time, location and activity information. Another example is AffectAura, which is a system that measures posture, head position. GSR, voice activity, and GPS to provide users with a visualization of their predicted affective state.

One common characteristic of technologies that support reflection is that they require the focused attention of the user. These technologies can help users to reflect about their past or current experiences, so that they can take actions to better regulate their emotions in future situations. However, this reflective practice cannot be performed concurrently with some tasks. If, for instance, an individual is involved in a demanding and stressful task, such as a business meeting or a public speech, she will not be able to pause or stop their current task to use one of these technologies. Indeed, technologies that focus on reflection are not designed to help users regulate their ongoing emotions.

In order to help users regulate their emotions while they are performing certain tasks, researchers have devised different real-time interventions. One of the most common real-time strategies is biofeedback. A system that uses this strategy detects the user's emotional state via physiological sensors and provides real-time feedback to help the user regulate their emotions. One example of such technology is MoodWings, which is a wearable device in the form of a butterfly that mirrors a user's real-time stress state through actuated wing motion. Although MoodWings was developed to calm down the users, the stress of the participants during a driving task actually increased with the intervention. In fact, researchers have acknowledged that there is a fine line between a stress intervention being effective and actually becoming a stressor.

Another issue of real-time interventions is that they may distract the user during the task, which can negatively influence the user's performance. In situations in which the performance of a task has become automatized, conscious thought about the task can impair the performance while performing it, which has been known as the “centipede effect” or “humphrey's law”. In some cases the intervention can even improve the performance of the user, but this may come with the cost of increased stress.

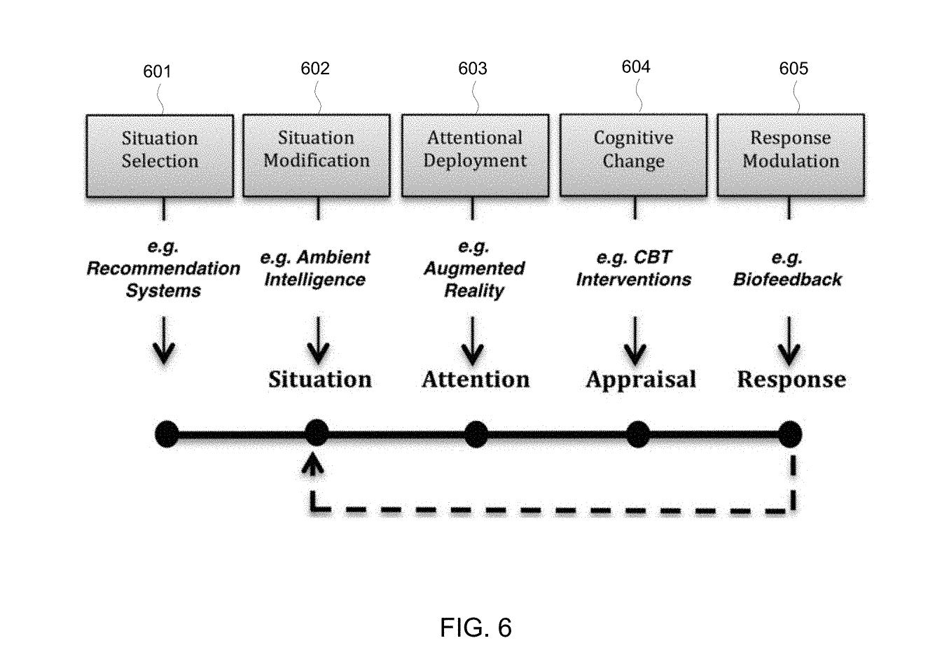

In order to design technological interventions that help users to regulate their emotions without compromising their behavior or stress, it is important to understand how human beings regulate their own emotions without the use of technological artifacts. Emotion regulation refers to “the processes by which individuals influence which emotions they have, when they have them, and how they experience and express these emotions.” James Gross provided a description of the various strategies that we can employ to regulate our emotions, which is termed as the “Process Model of Emotion Regulation”. According to the model, emotions may be regulated at one of five phases during the time course of emotion: situation selection, situation modification, attentional deployment, cognitive change and response modulation. FIG. 6 shows a representation of the model with examples of technologies for each phase. Each phase in the model of emotion regulation is described in this patent document.

The first phases in the model of emotion regulation are in a group called antecedent-focused emotion regulation. This group contains the phases that occur before the emotion is generated. The first phase in this group is situation selection 601, which refers to taking actions that make it more (or less) likely that one will be in a situation that one expects will give rise to desirable (or undesirable) emotions. One example of mobile application that can help users to avoid particular situations is Split. The application mines the location of friends and acquaintances from social updates and presents the information to the user so that he/she can avoid unwanted encounters.

Once selected, a situation may be tailored to modify its emotional impact. This constitutes the phase of situation modification 602. For instance, a person can change the music of an environment to lighten up the mood after a conflict. One type of technology that helps users to regulate their emotions through situation modification is The Affective Remixer, which collects physiological data of the user (GSR) and uses this information to rearrange the songs played in real-time, aiming to elicit changes in a listener's affective state.

Every situation contains several aspects that a person may decide to focus on. Attentional deployment 603 is the phase that refers to direct the attention of an individual with the goal of influencing their emotional response. One common strategy of attentional deployment is concentration, in which the individual draws attention to the emotional features of the situation. Examples of technologies that focus on concentration are the ones that help the user to conduct mindfulness meditation, such as mobile apps that help the user to focus on his own breathing.

The next phase in the model is cognitive change 604, that refers to modifying the way an individual thinks about a situation in order to alter the way he/she feels. The most commonly studied example of cognitive change is reappraisal, which involves reinterpreting the meaning of a stimulus, or evaluating the self-relevance of the situation. Many technologies that focus on cognitive change are based on principles of Cognitive Behavioral Therapy (CBT). One such application is Koko, which is a mobile social network that allow users to provide cognitive reappraisal and socioaffective support.

Finally, the last phase of the model of emotion regulation occurs after the emotion is generated. This phase is called response modulation 605, and corresponds to directly influence physiological, behavioral or experiential components of the emotional response after the emotion is in progress. One popular response modulation strategy is biofeedback. The idea of biofeedback is that by improving our self-awareness we can learn how to control normally involuntary functions, such as respiration and heart rate. One example of biofeedback technology is MoodLight, which is an interactive ambient lighting system that responds to the individual's current level of arousal.

Although many examples of emotion regulation strategies are conscious, emotion regulation can also be engaged implicitly. One example is when a person quickly turns away from upsetting material. Implicit emotion regulation may be defined as “any process that operates without the need for conscious supervision or explicit intentions, and which is aimed at modifying the quality, intensity, or duration of an emotional response.” Even though implicit emotion regulation is presumably unintentional, several lines of research emphasize that people engage in this form of emotion regulation to achieve their own goals. Implicit emotion regulation is crucial for our wellbeing, given the high demand for moment-to-moment emotion regulation in our everyday life.

According to Mauss et al., there are three main advantages of automatic and implicit emotion regulation: 1) it may consume little or no attentional capacity or subjective effort; 2) it can be activated quickly, effectively interrupting the development of an emotional impulse before it unfolds; and 3) it can avoid some of the “side effects” of deliberate emotion control. Therefore, implicit emotion regulation can avoid some of the negative concomitants of conscious emotion regulation.

Our environment contains significant cues that can trigger fast and automatic emotional responses. It has been shown, for instance, that we spontaneously imitate emotional facial expressions, which in turn can influence how we feel. However, what happens in our bodies can also trigger fast emotional reactions. As emotion regulation is associated with both attention to and awareness of one's emotional state, the way we perceive what is happening internally can directly influence our emotional experience.

The extent of an individual's sensitivity to their bodily signals is called interoceptive awareness. Some theories of emotions propose a close relationship between interoceptive awareness and emotional and cognitive processes. James and Damasio proposed that individuals that perceive bodily signals with a high level of accuracy should experience emotions more intensely. Several studies have been conducted to validate these theories, and researchers found that indeed there is a positive relationship between interoceptive awareness and the experience of emotions.

Previous studies demonstrate that there is a connection between the degree of a person's awareness of their heart rate and the intensity of emotional experience. In a classic experiment performed by Valins, male college students received auditory feedback of their heart rate reactions while seeing and rating the attractiveness of pictures of naked women. The participants that falsely believed their heart rate had changed (increased or decreased) attributed greater attractiveness to the images. In a more recent study, researchers found that good heartbeat perceivers showed greater emotional arousal to both positive and negative pictures.

Interestingly, recent studies indicate that interoceptive awareness is positively related to anxiety measures in healthy subjects. This relationship between interceptive awareness and anxiety is also found in clinical populations. Several studies show that individuals with anxiety disorders, such as social phobia and panic disorder, tend to have higher interoceptive awareness.

The field of psychology provides a significant body of work to understand how emotions are regulated. This section shows how a mobile intervention is designed to regulate anxiety by leveraging this body of work on emotion regulation and specifically Gross' model of emotion regulation. There are two main design goals for the intervention: 1) the intervention should be subtle, without requiring much attention or effort from the user to be effective; and 2) the intervention should help the user to regulate the target emotion. Three basic questions are considered in the design process: 1) what to regulate; 2) when to regulate; and 3) how to regulate?

During our daily life we are constantly regulating our emotions. However, in some cases our emotions take control, and it becomes difficult to regulate them effectively. One emotion that can be particularly difficult to regulate is anxiety. Anxiety is an emotion characterized by feelings of tension, worried thoughts and physical changes like increased heart rate, excessive sweating and cold hands. Experiencing occasional anxiety is a normal part of life. In fact, a certain amount of anxiety can even help individuals to face their challenges. Athletes, for instance, learn to regulate their anxiety so that they can have just the right amount. However, if the feelings of anxiety get too high they can interfere with our daily activities. For instance, anxiety can interfere with our performance during public speeches, exams, and job interviews. Therefore, learning to control our anxiety becomes the key to perform our activities in the best way possible.

The process model of emotion regulation posits that emotions may be regulated at one of five phases during the time course of emotion. In order to design mobile interventions that help users to regulate their anxiety, it is important to consider that depending on the context and the emotion one phase may be more feasible for an intervention than others. Since emotion regulation happens in a continuous way, an intervention that focuses on one phase of the model may lead to changes in the following phases.

The goal was to design an intervention to regulate user's anxiety. In this context, the phases of situation selection and situation modification are not the best options to target for an intervention. It can be hard for an individual to avoid certain activities and anticipate all aspects of every situation beforehand. For instance, a driver may need to face an inevitable car traffic and a business person may have to attend a meeting with a difficult client to ensure the success of the company. Therefore, individuals may eventually get involved in situations that would make them feel anxious. Interventions that focus on attentional deployment often require significant user's engagement to be effective, which is the case of mindfulness meditation. However, several studies show how individuals subtly pay attention to their bodily signals and implicitly react based on it. Furthermore, the awareness of our bodily signals, such as our heart rate, can automatically influence our cognition and emotional experience. For these reasons we decided to develop a subtle intervention that focuses on the phase of attentional deployment.

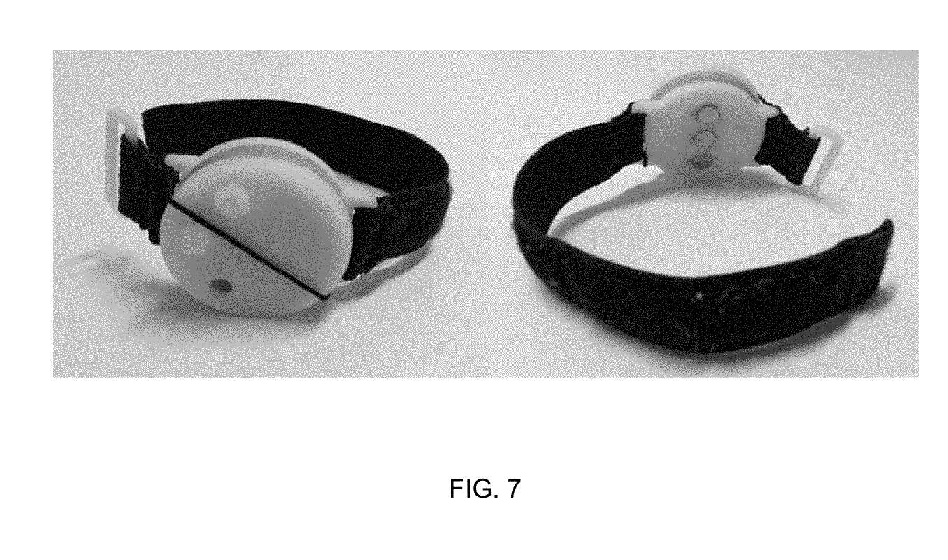

Previous studies demonstrate a positive relationship between interoceptive awareness and anxiety. Inspired by these previous studies, we designed and built a wearable device that influences people's perception of their own heart rate, which we call EmotionCheck. FIG. 7 shows an exemplary embodiment of the device. This particular embodiment is a watch-like device that produces subtle vibrations on the wrist simulating heartbeats. The technology can be used to simulate a bodily signal in order to influence the user to react to this signal just like he/she would while perceiving the signal without the technology.

Studies have shown that if an individual notices that his heart rate is very fast, this can intensify their feelings, making him feel more anxious. On the other hand, if this information is supplemented with another signal that indicates that the heart rate of the individual is slow, this may influence the way the individual appraises the situation, which in turn can make him feel more calm. With this idea in mind a wearable device is designed to replicate a slow heart rate (60 beats per minute or bpm). The hypothesis is that this device can help users to feel less anxious during stressful situations.

The EmotionCheck Device

The hardware design of the EmotionCheck device is similar to the design of many health-monitoring watches. This allows us to both maintain consistent placement and contact on the user's wrist while having a familiar form factor to help avoid drawing unnecessary attention to the device. To minimize the profile of the prototype, we designed and built a custom PCB. This allowed us to use surface mount chips, which help prevent the prototype from becoming bulky and provides more stable connections helping to prevent any loose connections due to vibration/movement.

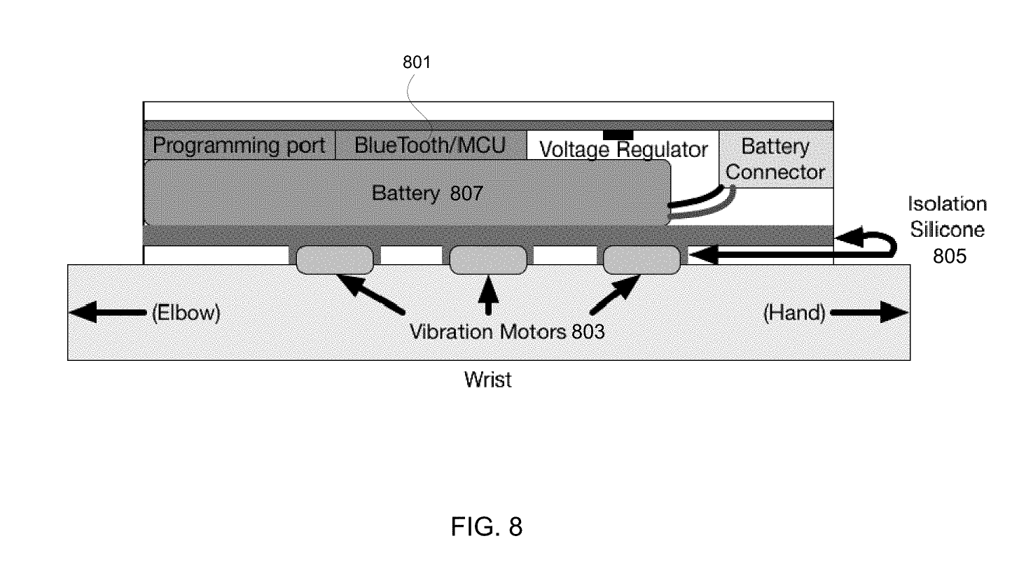

FIG. 8 shows an exemplary diagram describing the components of the EmotionCheck device. For example, in some embodiments, to control and communicate with the prototype, a BlueTooth Smart Transceiver/Controller is used with a microcontroller 801 (e.g., 16 MHz ARM Cortex-MO microcontroller, model RFD22301). The microcontroller may operate at 3.3V at 18 mA (4 mA ultra low power (ULP)) to transmit/receive current and may transmit on the 2.4 GHz band with a 4 dbm transmit power. The unit can be programmed over a breakout cable that connects to a USB shield (model RFD22121) via a SMD JST-SH connector.

In some embodiments, the device has three vibration motors 803 (e.g., shaftless/coin, Precision Microdrives 308-107 Pico Vibe) to provide haptic feedback that are connected to pulse width modulation outputs on microcontroller 801. In some implementations, the motors 803 are 8 mm in diameter with a length of 2.15 mm, have a 0.75 G typical normalized amplitude (each), and 15 k rpm vibration speed. In some embodiments, only two of the motors may be used, each vibrating with an approximate amplitude of 0.72 G with a vibration frequency of 220 Hz. The intensity of the vibration can be compared to someone lightly tapping the inside of their wrist. In order to minimize noise from the vibration that may be distracting to users, the motors can be isolated from the circuit and enclosure with silicone rubber 805 (e.g., shore hardness of 40A). The electronics are powered with a battery 807 (e.g., polymer lithium ion, 3.7V at 11 OmAh) that is regulated with a voltage regulator (e.g., 3.3V 800 mA linear STMicroelectronics LD1117S33TR).

The enclosure of the prototype may include cell cast Acrylic and Delrin (acetal resin) parts that are laser cut and bonded together. Using these strong plastics it can be ensured that the prototype can withstand the constant vibrations and tension of the band. For example, a 1-inch wide elastic band and Velcro are used to make the wristband. Furthermore, a Hook and Loop Cinch Strap buckle design is used to ensure that the wristband would fit comfortably and firmly regardless of wrist size.

In some embodiments, the device includes a heart rate sensor coupled to the user to sense a heart rate. In some implementations, the heart rate sensor can be positioned within the enclosure or close to one side of the enclosure to sense the heart rate. For example, a smartwatch based heart rate measurement can be performed to obtain a sensed heart rate.

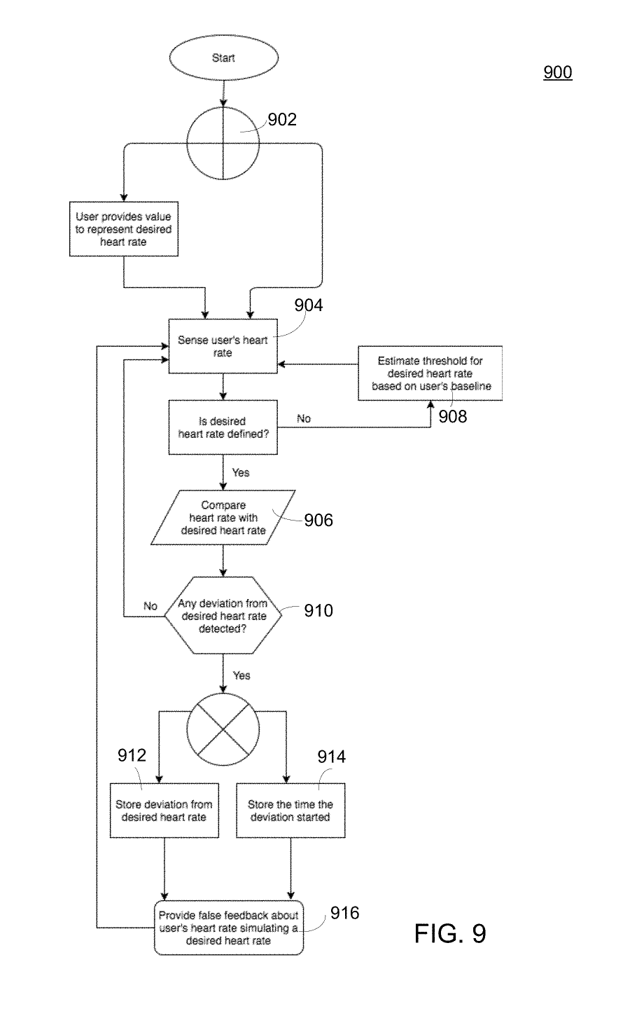

FIG. 9 shows a flowchart representation of a method 900 of influencing a user's anxiety level. The method can be implemented on the microcontroller of the device shown in FIG. 7 or FIG. 8. The method 900 includes receiving, at 902, values from the user to represent a desired heart rate. The method 900 then includes sensing, at 904, the user's heart rate using one or more sensors. If a desired heart rate has been defined in step 902, the method 900 proceeds to compare, at 906, the sensed heart rate with the desired heart rate. On the other hand, if the desired heart rate is not yet defined, the method 900 estimates, at 908, a threshold for the desired heart rate based on user's baseline heart rate. The user's baseline heart rate may be gathered by averaging sensed heart rate over a period of time. Alternatively, the user's baseline heartrate may be programmed by the user through a user interface of the user device. The method 900 then includes determining, at 910, if there is any deviation in the sensed heart rate from the desired heart rate. If yes, then the method 900 proceeds to store the deviation from the desired heart rate (912) and the time when the deviation starts (914). The method 900 further includes providing, at 916, false feedback to simulate a desired heart rate to the user.

Experiment Design

In order to test the effectiveness of the EmotionCheck device, a laboratory experiment was conducted with a between-subjects design by comparing the anxiety scores of the participants across four conditions. All conditions of the experiment are listed below.

In the control group condition, participants used the EmotionCheck device, but they did not feel any vibration during the tasks. In the vibration condition, participants felt the vibrations on the wrist at a frequency of 60 bpm (the precision may be plus-minus 10%). They were informed that they would feel vibrations on the wrist, but no additional information was provided. In the slow heart rate condition, participants also felt the vibrations on the wrist at a frequency of 60 bpm, but they were informed that the vibrations would always represent their current heart rate. In the real heart rate condition, participants were informed that the vibrations would always represent their current heart rate, and the vibrations were indeed changing based on the heart rate of the participant.

The study was conducted in a sound-treated room in an academic department. There were no personal or decorative items in the rooms; each space contained a small table and two chairs. The rooms were set up with one laptop on the table, which was used by the participants to watch a calming video and to complete the questionnaires. Next to the laptop were the following devices: i) EmotionCheck device ii) Heart rate monitor (Polar H7). In order to keep all experimental conditions of the study uniform, the devices were used by all participants. The EmotionCheck device was used to manipulate the conditions of the study. The data collected by the heart rate monitor was used only in the real heart rate condition, in order to adjust the vibrations accordingly.

Sixty-eight subjects participated of the study, of whom forty-three were female. All participants were students at a large US university. Participants ranged from 19 to 30 years of age.

In this study a between-subjects design is used to test the hypotheses. Before the tasks, the participants completed a consent form in which they were introduced to the study. In order to avoid bias in the results, the participants were not informed that the purpose of the study was to evaluate if the EmotionCheck device can help to lower their anxiety. Instead, they were informed that they would participate in a study to understand people's behavior during job interviews. The experiment was conducted as follows.

The experiment was an adaptation of the Trier Social Stress Test, which is a widely used protocol to induce stress and state anxiety in participants. Before the experiment, the participants were asked to watch a calming video of a slow train ride in Norway, shot from the front window of the locomotive. This phase had a duration of 5 minutes, and it was used to collect baseline data.

After the resting phase, the participants were asked to complete a series of questions about their demographics, state and trait anxiety. Once the questionnaires were completed, the participants received instructions to imagine that they were about to interview for their dream job and that they would have 5 minutes to prepare a presentation (preparation phase) and 5 minutes to present themselves to an experienced evaluator detailing their strengths, qualifications, and why they should be chosen for the job (presentation phase).

In the preparation phase, the participant received a paper and pen for outlining their presentation. However, they were not allowed to use the written notes during their presentation. The researcher activated the randomized condition for the EmotionCheck device in the beginning of this phase. The phase had a duration of 5 minutes.

In the presentation phase, a male confederate entered the room and asked the participant to stand up. The confederate then turned on a video camera, sat in front of each participant and asked him/her to deliver the talk. Whenever the subject stopped talking for more than 10 seconds, the confederate responded in a standardized way: “You still have some time left. Please continue!” During each presentation, the confederate did not make any comment or expressed any kind of nonverbal behavior, such as nodding or smiling. This phase had a duration of 5 minutes. After the end of this phase, the researcher stopped the randomized condition.

Once the participants finished their presentation, they were instructed to complete some questionnaires, including the State Anxiety Inventory and questions about the vibrations. After completing all tasks, the participants received a sheet of paper with detailed information about the goal of the study.

Previous studies indicate that there is a positive relationship between the degree of a person's awareness of their heart rate and the intensity of emotional experience. Furthermore, studies demonstrate that interoceptive awareness is positively related to anxiety measures in healthy subjects. Given this positive relationship between interoceptive awareness and anxiety, we hypothesized that by manipulating people's perception of their heart rate we can influence their state anxiety. In this case, individuals that perceive a slow and steady heart rate would feel less anxious. This leads to the first hypothesis:

Hypothesis 1 (H1): The anxiety scores of the slow heart rate group will be lower than the anxiety scores of the control group.

Even if the hypothesis 1 is supported, it may be due to other factors related to the use of vibrations. For instance, the vibrations can act as minor distractions, which can make the person to not pay attention to negative cues either internally or in the environment. However, there are not studies indicating that this kind of distraction can help users to lower their anxiety. Therefore, this leads to the second hypothesis:

Hypothesis 2 (H2): The anxiety scores of the vibration group will not be different from the anxiety scores of the control group.

Finally, the experiment was designed as an adaptation of the Trier Social Stress Test, which is a protocol that has been used to induce stress and state anxiety. Several studies demonstrate that this protocol increases the heart rate of the participants during the stressful tasks). Since there is a positive relationship between interoceptive awareness and anxiety, by augmenting people's awareness of their heart rate they may notice that the heart rate is getting faster, which can make them feel more anxious. This leads to the last hypothesis:

Hypothesis 3 (H3): The anxiety scores of the real heart rate group will be higher than the anxiety scores of the control group.

In order to measure people's anxiety before and after the intervention, the State-Trait Anxiety Inventory (STAI), which is a psychological inventory consisting of 40 self-report items pertaining to anxiety affect, was used. The STAI consists of 20 items to assess state anxiety, and another 20 items to assess trait anxiety. The state anxiety questionnaire includes items such as “I am worried; I feel calm,” while the trait anxiety inventory includes questions such as “I worry too much over something that really doesn't matter.” All items are rated on a 4-point scale, ranging from “Not at all” to “Very much so” in the state anxiety questionnaire, and from “Almost Never” to “Almost Always” in the trait anxiety questionnaire. Once a person completes one questionnaire, a resulting score that ranges from 20 to 80 can be obtained. Higher scores indicate greater anxiety. The STAI has been used extensively in several studies to measure how people's state of anxiety change after each experimental condition.

In order to evaluate how people reacted to the vibrations, a questionnaire was included with questions about how distracting were the vibrations. Open-ended questions that would allow us to get more information about how people felt and how the vibrations affected them were also included, such as: (a) how did you feel during the presentation: (b) how did you feel during the preparation phase; (c) did you get distracted with the vibrations; (d) do you think the vibrations affected your performance? if yes, how; and (e) what do you think was the purpose of the vibrations in the wristband?

Finally, demographic information was collected to verify if there were differences across groups that can confound our results.

It was confirmed that there were no initial group differences at baseline that can confound our results. There were no baseline group differences in Gender (p=0.88). Age (p=0.15). College Education (p=0.10), Trait Anxiety (p=0.26) and Pre-state Anxiety (p=0.15). Furthermore, an inspection of the answers to the question “what do you think was the purpose of the vibrations in the wristband” revealed that most participants thought that the purpose of the vibrations was to act as a distraction.

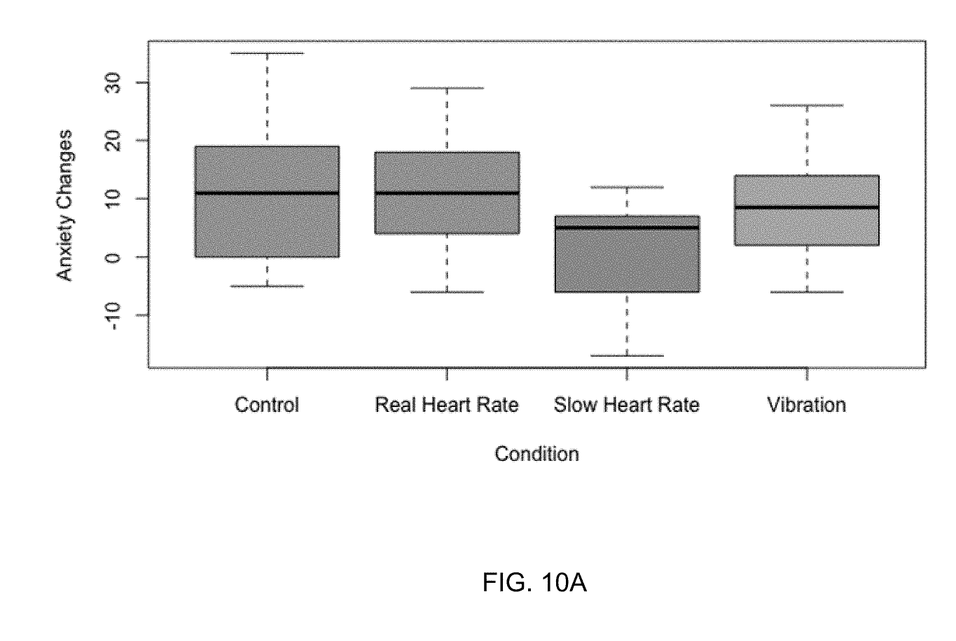

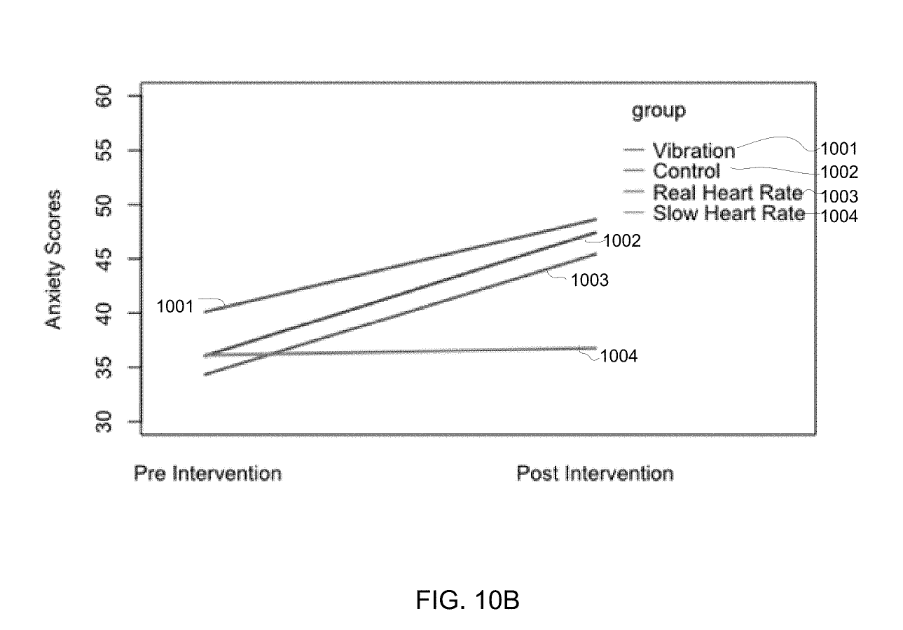

A two-way repeated measures ANOVA was performed to compare the anxiety scores across the four groups considering the two phases in which the data was collected (pre intervention and post intervention). FIG. 10A shows an exemplary interaction plot that indicates how the anxiety scores changed in each group after the intervention. Additionally, the anxiety changes (post anxiety-pre anxiety) were analyzed using paired t-tests with bonferroni correction. FIG. 10 shows a boxplot of the anxiety changes. Descriptive statistics of the anxiety changes are found in Table 1 and results of the paired t-tests are shown in Table 2.

TABLE 1
Descriptive statistics and effect sizes based on
anxiety changes

| | Mean | SD | Cohen's d |
|---|---|---|---|
| Control | 11.35 | 11.4 | |
| Vibration | 8.5 | 8.97 | 0.28 |
| Slow Heart Rate | 0.65 | 8.45 | 1.07 |
| Real Heart Rate | 11.06 | 10.21 | 0.03 |

TABLE 2
Results of the paired t-tests using Bonferroni correction.

| | Control | Real HR | Slow HR |
|---|---|---|---|
| Real HR | 1 | — | — |
| Slow HR | .014* | .018* | — |
| Vibration | 1 | 1 | .152 |

*indicates p < 0.05.

The ANOVA analysis revealed a statistically significant difference (F(3.63)=3.37, p=0.02). The pairwise comparisons revealed that the anxiety scores of the slow heart rate group were statistically significantly lower than the control group (p=0.014) and the real heart rate group (p=0.018). The effect size was large in both comparisons. The analysis indicates that the slow heart rate intervention was responsible for making the anxiety of the participants to be lower than in the control group. No statistically significant effect was found for the other interventions when compared to the control group.

The results of the survey analysis were corroborated with the feedback received in the open-ended questions. Some participants in the slow heart rate group reported calming effects of the vibrations. One participant remarked: “I have a job interview tomorrow and it would be great to use a device like this because it actually helped me to calm down.”

Similarly, another participant in the slow heart group mentioned how the vibrations helped him to keep steady: “Since my pulse was pretty steady I think it kind of helped me to keep steady as well. I think it is something like music and having a metronome in the background.”

One participant in the slow heart rate condition stated that he did not believe that the heart rate feedback was accurate, but he still acknowledged an effect of the intervention: “I have trouble believing that my heart rate was so slow and steady throughout that task, but thinking that it was during the talk actually helped me to not be nervous.”

Participants of the slow heart rate group mentioned how the vibrations were used to evaluate the situation and how they were feeling. For instance, one participant remarked: “I started to pay attention to the feedback whenever I stopped talking. I was stressed but after noticing the vibrations I thought ‘Ok, my heart rate is not that high’.”

In the real heart rate group, some participants stated that the increasing heart rate made them feel more nervous or stressed. One participant remarked: “When I was writing I started to notice my heart increasing and I started to get worried about that. When I realized that my heart rate was increasing I felt more nervous.”

Similarly, another participant mentioned that the vibrations acted as a feedback loop: “I felt that specially after running out of ideas the vibrations made me a little bit more stressed. It kind of felt like a feedback loop so as the vibrations increased it also increased my mental stress.”

Some participants in the real heart rate group also mentioned how their awareness of the vibrations influenced their emotion regulation strategies. One participant mentioned: “The vibrations made me more aware of my heart rate. It was not something that I was constantly thinking but in the back of my mind I was thinking ‘I want to make it more constant’.”

Similarly, another participant from the same group reported that he noticed when the vibrations got faster and he thought that he should do something about it: “I noticed when the vibrations started to get faster and I thought ‘Ok, I have to chill out a little bit’.”

Although some participants used the vibrations as an input for their self-regulation, it did not translate into low anxiety levels to all of them. R4, for instance, increased their subjective anxiety in 25 points, which is higher than the overall mean (8.06) and the mean of the real heart rate group (11.06).

In order to evaluate if the intervention distracted people's attention during the tasks, we evaluated their responses to the question “Do you think the vibrations distracted you?”. The responses ranged from 1 (‘Not at all’) to 5 (‘Very much’). Table 3 shows descriptive statistics of the results. Most participants in all conditions reported “Not at all” when asked if the vibrations distracted them. In the slow heart rate group 11 participants reported ‘Not at all’, 5 participants reported ‘A little bit’ and 1 participant reported ‘Somewhat’.

TABLE 3

| | Mode | Median | Min | Max |
|---|---|---|---|---|
| Vibration | 1 | 1 | 1 | 4 |
| Slow Heart Rate | 1 | 1 | 1 | 3 |
| Real Heart Rate | 1 | 1 | 1 | 3 |

When asked about the vibrations in the open-ended questions, most participants reported that they did not pay much attention to them. In the slow heart rate group, one remarked: “I felt the vibrations especially when I was sitting but most of the time I was too distracted to pay attention on them.”

Similarly, one participant from the real heart rate group mentioned that he did not notice the vibrations during the presentation: “I didn't feel distracted. I think it was just in the back of my mind. I was mostly focusing on the tasks at hand.”

Some participants in the slow heart rate group reported that they were paying attention to the vibrations during the preparation phase but not that much during the presentation. One participant remarked: “During the preparation phase I was consciously paying attention to the vibrations but during the presentation I was not.” Another participant made a similar statement: “I noticed the vibrations the most during the preparation phase.”

Although most participants reported that the vibrations did not distract them, some participants reported that the vibrations were a little distracting. One participant from the real heart rate group reported: “The vibrations were a little distracting but not enough to completely turn me off.” Similarly, one participant from the vibration group mentioned that the vibrations were irritating, but she decided to ignore them: “The vibrations were a little irritating but I pushed it out.”

Discussion

One of the hypotheses of this study was that the participants in the slow heart rate group would have a lower anxiety when compared to the control group (H1). The results of the study support this hypothesis. On average, the participants in the slow heart rate group increased their anxiety in 0.65 points, which is way lower than the anxiety increase in the control group (11.35) and in the other conditions. FIG. 10B shows an exemplary interaction plot of the changes in the average anxiety scores. The interaction plot clearly indicates that the stressful tasks increased the anxiety of the participants in all groups (vibration 1001, control 1002, real heart rate 1003), except in the slow heart rate group 1004. Furthermore, even though the participants were not informed about the purpose of the vibrations, some participants in the slow heart rate group 1004 explicitly mentioned how the heart rate feedback helped them to “calm down”, to “not be nervous”, or “to feel steady”. None of the participants in the other conditions mentioned these positive effects. It is important to note that the results of the vibration group 1001 show that the vibrations alone did not lead to lower anxiety levels in the participants, so the hypothesis 2 was also supported (H2). The fact that both hypotheses H1 and H2 were supported indicates that the lower anxiety of the participants in the slow heart rate group was a consequence of their belief that the vibrations were representing their heart rate, rather than a consequence of the slow and steady vibrations alone.

Another hypothesis of this study was that the real heart rate feedback would lead to a higher anxiety of the participants when compared to the control group (H3). The quantitative results of the study do not support this hypothesis. However, some participants stated that they felt more nervous and stressed when they noticed that their heart rate was increasing through the vibrations. These participants also reported that the vibrations distracted them “A little bit”, so it is possible that the increase in anxiety in these participants was a consequence of paying too much attention to the increasing vibrations.

One question that arises is if the slow heart rate intervention is also effective when the participants know beforehand that the vibrations do not represent their actual heart rate. Even though we have not tested this hypothesis in this study, there are some points to consider. First, one participant in the slow heart rate group acknowledged that he did not believe that the feedback was accurate, but he still thought that the intervention helped him to calm down. Second, 11 out of the 17 participants in the slow heart rate group reported that the vibrations did not distract them at all, and many participants mentioned that they were not paying attention to the vibrations, especially because they were concentrated on their current tasks. Previous studies indicate that our behaviors and emotions can be subtly influenced by internal and external cues even when we are not consciously paying attention to these cues. Therefore, it is possible that the intervention may affect the emotional state of individuals even when they are not able to infer if the heart rate feedback is accurate or not.

In order to investigate what happens when individuals know that the feedback might not be accurate, we plan to conduct a longitudinal study and tell the participants in advance that the vibrations that they will feel may accurately represent their heart rate or not. In some cases users can receive real heart rate feedback, and in other situations they would receive false feedback. In this way, users would know in advance that the feedback can be inaccurate, but they would not know when. By using this approach, a mobile technology can automatically detect when the user is anxious and then manipulate the feedback provided in order to help the user to calm down when needed.

The results of this study demonstrate that the slow heart rate intervention was effective, and that most participants did not get distracted by them. Many participants reported that they were focused on the presentation and that they did not pay attention to the vibrations because of that, although they can still notice them. In addition, some participants mentioned that even though they were concentrated on their current tasks, in the “back of their minds” they were noticing the vibrations. These results indicate that the vibrations stayed in the periphery of people's attention, so the participants were attuned to the vibrations without attending to them explicitly.

The results of the study also indicate that some participants in the real heart rate group consciously used the vibrations as an input to regulate their emotions. For instance, one participant mentioned that he noticed when the vibrations started to get faster and after that he thought that he should “chill out a little bit”. However, the participants that reported that explicitly used the vibrations to regulate their emotions had some of the highest anxiety levels in the group. These results suggest that an intervention that leads the user to be overly attentive to their bodily changes may not the best solution during stressful tasks.

Other Implications

The results have broad implications for the HCl and Ubicomp community. The findings suggest that it is possible to design subtle mobile interventions that help individuals to regulate their emotions during emotional situations. These findings offer a myriad of possibilities for the design of technologies for emotion regulation.

One consequence of the findings is the possibility of developing technological interventions that can help users regulate their emotions without requiring explicit instructions or additional tasks. A common problem of some technologies that help users regulate their emotions is that they often require users to perform certain tasks. This may lead to compliance issues, in which users fail to follow the instructions properly or fail to persist with the proposed activities. For instance, a review of 46 computerized interventions for anxiety and depression found that the median completion rate was only 56%. Since the intervention works by leveraging our natural and implicit reactions to our bodily signals, the intervention can work right after the user start to use the technology, without requiring any additional action that the user would normally do. Therefore, users can keep doing their tasks and the intervention will work without distracting or overwhelming the user with new information.

Another implication of the study is the fact that it is possible to help users regulate their emotions using simple interventions. In applications that focus on reflection of emotional experiences, users may benefit of having rich user interfaces that provide detailed information about their past experiences. However, in situations in which users are engaged in stressful and demanding tasks, it is important to not overwhelm the user with new information during these tasks, since the increase in cognitive load may affect people's performance or even increase their stress. The results indicate that it is possible to keep users' anxiety in low levels by using a simple cue of a slow heart rate.

One important consideration to make is that in real world situations it may be important to personalize the feedback according to the situation and the user, in order to increase the effectiveness of the intervention. Although the results of our study show that a false feedback simulating a slow heart rate (60 bpm) produced significant effects in the group, some subjects responded to the intervention better than others. It is possible that individuals varied in their awareness of how fast were the vibrations, even though the vibrations were the same for everyone in the slow heart rate group. In order to take into account individual differences, a technology can use people's heart rate and their interoceptive awareness as an input to adjust the false feedback accordingly. For instance, rather than simulating a pulse of 60 bpm, the device can reproduce a vibration 20% lower than the person's heart rate.

The finding that real-time feedback did not help the participants to feel less anxious challenges the idea that real-time representation of internal emotional states is helpful during stressful tasks, which is a common approach used in affective computing. Results of a previous study indicate that it is more beneficial to be exposed to stimuli that suggest progress rather than real-time feedback when users are actively performing exercises to reduce stress. The results complement this finding, by showing that false feedback that suggests a calm heart is more effective than real heart rate feedback in situations in which users are engaged in anxious and stressful tasks.

The results of the experiment provide evidence that a subtle feedback of a slow heart rate can help individuals to manage their anxiety. Since the experiment was conducted in a laboratory environment, two questions arise: how EmotionCheck can be used in practice and when the intervention should be triggered?

The most plausible use of EmotionCheck is to act when the user is feeling anxious or stressed, such as during exams, public speeches, business meetings or job interviews. In the current implementation, the intervention is triggered by pushing a button in one Android application. The user can push this button when he knows that he is experiencing or he is likely to experience an anxious and stressful situation.

The system can also be extended to allow the automatic activation of the slow heart rate feedback. The feedback can act as a just-in-time intervention that is triggered only when an external sensor detects that the user is anxious or stressed. Another approach would be the use of a predictive system, that would trigger the intervention right before activities that are likely to make the user to feel anxious. For instance, the system can use calendar information and historical data about user's emotions to predict that the user is likely to feel anxious in a next meeting with their manager.

One interesting possibility is the use of EmotionCheck by clinical populations. Since previous studies show that individuals with anxiety disorders such as social phobia and generalized anxiety tend to have higher interoceptive awareness, a technology like EmotionCheck can assist anxious people to cope with their anxiety. For individuals with social phobia, for instance, a system can trigger the intervention whenever the user is having a face-to-face interaction.

Another possibility for future research is to investigate what happens when the mobile technology simulates a faster heart rate. Even though our goal in this study was to test if a false heart rate feedback can help subjects to feel calmer, in some circumstances individuals may want the opposite effect. For instance, a driver that gets sleepy during long drives may benefit of having a technology that increases his arousal and level of alertness while driving. Since a fast heart rate is associated to the activation of the sympathetic nervous system, it may be possible to increase the arousal of the driver to reduce their drowsiness. In this case, the feedback can be provided directly through the seat belt or the car seat. This form of intervention can also be used by athletes or students who want to increase their focus while studying.

Design Considerations

The design considerations are based on System 1 theories and the findings from designing and evaluating mindless technologies.

Reflexive not Reflective

One characteristic of a System 1 process is that it happens quickly and automatically, so in order for a persuasive technology to be a mindless technology it should leverage this attribute. While many persuasive technologies based on System 2 focus on reflection, the technologies based on System 1 should focus on reflex. The technology should provide a simple and straightforward intervention, resulting in an immediate response of the user. In order to trigger a behavior automatically, researchers can leverage techniques and utilize findings from previous studies, especially from psychology and behavioral economics research. Researchers can also take into account pre-existing associations to colors, sounds, smells and touches. The color red, for instance, can be automatically associated to hot temperatures and to the action of stopping something. A pleasant sound can be associated to calmness and positive feelings.

Another consideration that should be taken into account in regards to instantaneous influence is that behavior change should not be evaluated as a long-term process, but as a short-term process that happens right after or in parallel with the intervention. Therefore, it is important to evaluate if the trigger is igniting the behavior automatically as expected for that instance. However, the behavior influence can still lead to long-term effects through repetitive instances of influence (as shown in the project PianoTouch, which uses haptics for passive learning).

Focus on Triggers

An issue of behavior change technologies that rely on the reflective mind (System 2) is that they often require users to be heavily motivated or have a strong ability to perform a behavior. In technologies based on System 1 processes, on the other hand, the reliance on user's motivation and ability is smaller, since the behaviors can be triggered automatically. Therefore, triggers should be the main focus of designers of technologies based on System 1.

One aspect to take into account when designing a mindless technology is that the trigger will be more effective if it is somehow embedded into people's daily routines. In Rogers et al., the subjects were walking in the same environment that they would without the intervention, but with the presence of twinkly lights on the floor they were subtly influenced to take the stairs. With the Mindless Plate, users can serve their foods just like they would every day, but because of the lights triggering the Delboeuf illusion they can be subtly influenced to put less food than usual.

Parallel not Serial

In order to achieve parallel functionality in a technology, the stimuli should be subtle enough so that the user does not have to think about the nudging feature. Therefore, instead of presenting information for the user to reflect, or reminding the user about a task to do, the technology should provide a simple trigger that influences the behavior of the user without distracting him from the current task. This can be attained in two ways. First, the trigger can be so subtle and covert that the user cannot perceive it. This kind of trigger can cause subliminal effects, affecting user's behaviors even without being noticed. Second, the trigger can be overt and easily perceived, but the users do not realize that these triggers are affecting their behaviors. Both examples described in this paper fall in this category. In this last case, the cues act in the periphery, so users get attuned to them without attending to them explicitly.

One consideration to achieve parallel functionality is that the mindless technology should not require any additional effort while the user is performing an activity. One way of accomplishing that is by providing a cue to the user that is not very different from what the user would normally experience in his daily life. For instance, in the mobile application designed to influence people's voice the user can hear his voice in a way that is very similar to what he normally hears. A loud voice feedback would attract attention to the technology itself, which would be very disruptive during social interactions. Another way of accomplishing this seamless integration with people's activities is by designing a technology embedded in an everyday object. In this case, the mindless technology should contain the same affordances as its non-technological counterpart. The Mindless Plate, for instance, can be used like a normal plate, without requiring the user to do something different from what he would normally do.

Don't Ask, can't Tell

Since System 1 works in an implicit an unconscious way, researchers can have problems to evaluate their technologies based on System 1. Users can change their behaviors without being aware of it, so the information obtained from interviews or surveys can be misleading. In Rogers et al., for instance, the authors had conflicting results with the displays deployed to encourage individuals to take the stairs instead of the elevator. While few people admitted changing their behavior in response to seeing the displays, the logged data showed a significant increase in the stair usage after the installation.

The contradictory result found in Rogers et al. can happen in any study based on a persuasive technology that relies on System 1. As discussed in Negri et al., information perceived without conscious awareness can ignite implicit cognitive processes that the participant may not be able to discuss about. Therefore, researchers should be careful to draw conclusions based on information reported by participants. The participants can provide insights about the success of the intervention, but it is important to collect data in ways that does not rely entirely on participant's responses. For instance, in the voice influence study the voice of the participants was recorded and analyzed later to check if the pitch changed. In Arroyo et al., the authors used sensors to detect when people used the water fountain.

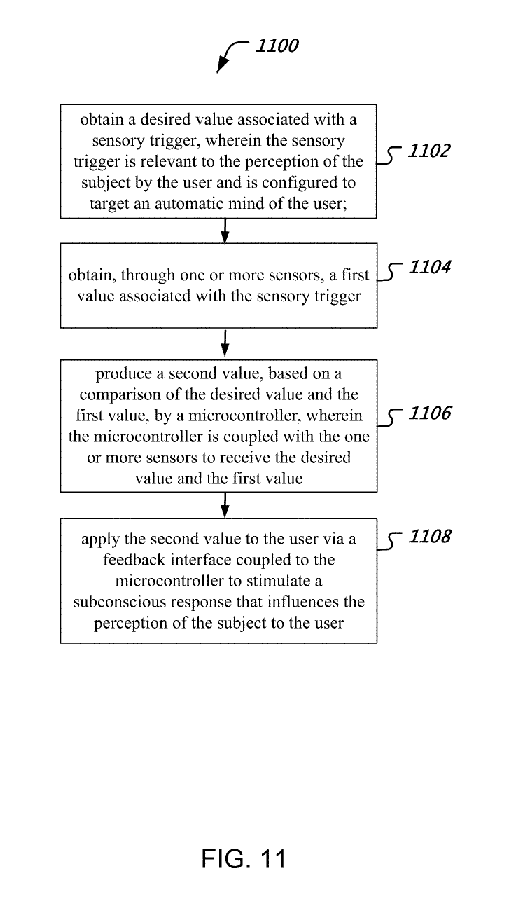

As shown in FIG. 11, this patent document discloses a method 1100 for influencing a user's perception of a subject. The method 1100 includes, at 1102, obtaining a desired value associated with a sensory trigger, wherein the sensory trigger is relevant to the perception of the subject by the user and is configured to target an automatic mind of the user. The desired value associated with a sensory trigger may be programmed based on user preferences (e.g., specific to a particular user) or may be based on a range or a specific value calculated a priori based on a sample set of several users. The method 1100 may include, at 1104, obtaining, through one or more sensors, a first value associated the sensory trigger from the user; at 1106, producing a second value, based on a comparison of the desired value and the first value, by a microcontroller, wherein the microcontroller is coupled with the one or more sensors to receive the desired value and the first value; and, at 1108, applying the second value to the user via a feedback interface coupled to the microcontroller to stimulate a subconscious response that influences the perception of the subject to the user. In some embodiments, the sensed feedback from the user may not be limited to only the sensory trigger that is applied to the user, but may include other sensory feedbacks. For example, a tonal (audio) or a tactile (vibration) feedback may be provided to the user, while user's body temperature, skin humidity, voice quality, heart rate. etc. may be sensed.

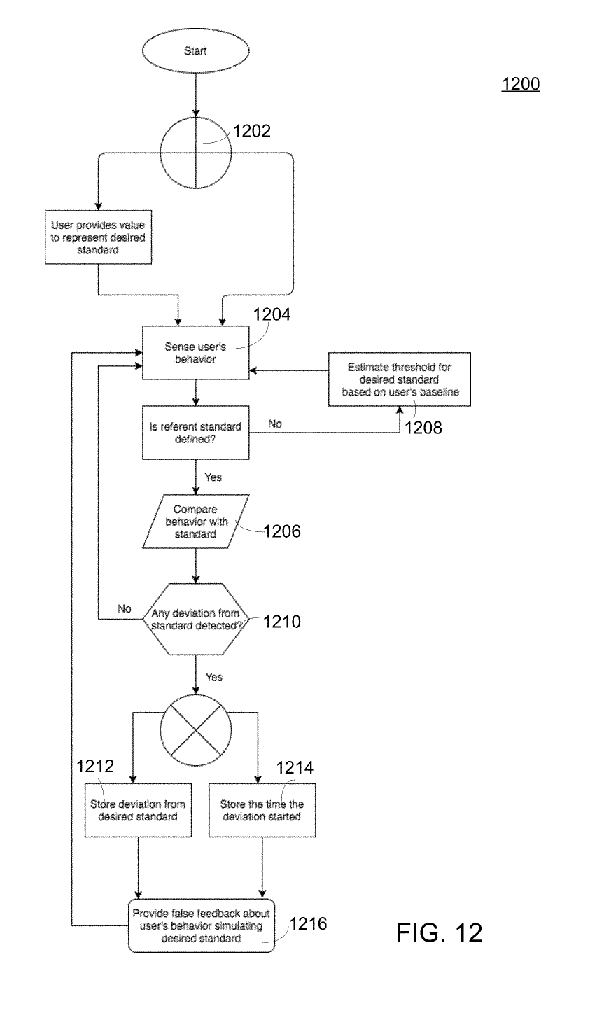

FIG. 12 shows a flowchart representation of an exemplary process 1200 using mindless technologies. The process 1200 includes receiving, at 1202, values that represent a desired standard from a user. The values may vary according to the context in which the technology is used. For example, in the case of voice manipulation, the values are based on empirical data showing how particular voice features lead to a certain perception (e.g., power, dominance, or, competence). In some embodiments, the values are stored in one or more look-up tables, each table representing data for a certain characteristic (e.g., power, dominance, or, competence). The user can pick one particular characteristic that he or she wants to embody, such as power, and the technology can automatically use the stored data to modulate the voice to elicit this characteristic. In some embodiments, information from the user can be collected automatically to adjust the values using techniques such as machine learning. For instance, a user who speaks with a very weak voice may want to feel and behave more powerful. The disclosed technology can detected the user's voice characteristic by analyzing how the user speaks, and adjust the desired standard (e.g., parameters of the modulation) to help the user improve their behavior (e.g., talk in a more confident and powerful way).

The method 1200 then includes sensing, at 1204, the user's behavior. If a standard is defined in step 1202, the method 1200 proceeds to compare, at 1206, the sensed voice behavior with the desired standard. On the other hand, if the desired standard is not yet defined, the method 1200 estimates, at 1208, a threshold for the desired standard based on the user's baseline. The method 1200 then includes determining, at 1210, if there is any deviation in the sensed behavior from the desired standard. If yes, then the method 1200 proceeds to store the deviation (1212) and the time when the deviation starts (1214). Then, the method 1200 includes providing, at 1216, false feedback simulating a desired standard to the user.

It is thus evident that, mindless technologies can provide a subtle but perceptible stimulus to a user, thereby influencing the way the user experiences their activities subconsciously, which in turn can trigger automatic behavioral responses. Mindless technologies impose minimal distractions to the user and are capable of influencing the user's behavior without requiring explicit instructions from the user.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules, such as microcontrollers, using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed are:

1. A method for influencing a user's perception of a subject, comprising:
obtaining a desired value associated with a sensory trigger, wherein the sensory trigger is relevant to the perception of the subject by the user and is configured to target an automatic mind of the user;
obtaining, through one or more sensors, a first value associated the sensory trigger from the user;
producing a second value, based on a comparison of the desired value and the first value, by a microcontroller, wherein the microcontroller is coupled with the one or more sensors to receive the desired value and the first value; and
applying the second value to the user via a feedback interface coupled to the microcontroller to stimulate a subconscious response that influences the perception of the subject from the user.

2. The method of claim 1, comprising:
obtaining, through the one or more sensors, one or more additional values that are associated with the sensory trigger, and
producing the second value based on a comparison of the desired value, the first value, and one or more additional values.

3. The method of claim 1, wherein the sensory trigger includes a visual trigger, an auditory trigger, a gustatory trigger, an olfactory trigger, and a tactile trigger.

4. The method of claim 3, wherein the sensory trigger further includes a vestibular trigger, a kinesthetic trigger, a trigger for thermoception, and a trigger for nociception.

5. The method of claim 1, wherein the one or more sensors include at least one color sensor and at least one force sensor.

6. The method of claim 1, wherein the one or more sensors include at least one audio sensor.

7. The method of claim 1, wherein the one or more sensors include at least one haptic sensor.

8. The method of claim 1, wherein the feedback interface includes a visual feedback interface.

9. The method of claim 1, wherein the feedback interface includes an auditory feedback interface.

10. The method of claim 9, wherein the auditory feedback interface is a headphone.

11. The method of claim 1, wherein the feedback interface includes a haptic feedback interface.

12. The method of claim 11, wherein the haptic feedback interface comprises a plurality of vibration motors.

13. A system for influencing a user's perception of a subject, comprising:
an input interface for obtaining a desired value associated with a sensory trigger, wherein the sensory trigger is relevant to the perception of the subject by the user and is configured to target an automatic mind of the user;
a sensor for obtaining a first value associated the sensory trigger from the user;
a microcontroller coupled to the sensor for producing a second value based on a comparison of the desired value and the first value, wherein the second value is different from the first value; and
a feedback interface coupled to the microcontroller for applying the second value to the user to stimulate a subconscious response that influences the perception of the subject to the user.

14. The system of claim 13, further comprising:
one or more additional sensors for obtaining one or more additional values that are associated with the sensory trigger.

15. The system of claim 14, wherein the sensor and the one or more additional sensors include at least one color sensor and at least one force sensor.

16. The system of claim 13, wherein the sensor is an audio sensor.

17. The system of claim 13, wherein the sensor is a haptic sensor.

18. The system of claim 13, wherein the feedback interface includes a visual feedback interface.

19. The system of claim 13, wherein the feedback interface includes an auditory feedback interface.

20. The system of claim 19, wherein the auditory feedback interface is a headphone.

21. The system of claim 13, wherein the feedback interface includes a haptic feedback interface.

22. The system of claim 21, wherein the haptic feedback interface comprises a plurality of vibration motors.

23. A device for influencing a user's perception of an amount of food held by the device, comprising:
a transparent plate;
a color sensor coupled to a bottom of the transparent plate, the color sensor configured to sense a color of light from a top of the transparent plate;
a force sensor positioned within the transparent plate configured to sense a weight of the food;
a plurality of light emitting devices uniformly distributed below the transparent plate; and
a microcontroller configured to adjust, based on the sensed color of light and the sensed weight of the food, the plurality of light emitting devices to change a perceived color of the transparent plate.

24. The device of claim 23, wherein the transparent plate includes a diffused acrylic surface.

25. A system for influencing a voice of a user, comprising:
a microphone configured to capture a first voice of the user;
a processor;
one or more memories configured to store instructions, when executed by the processor, causing the processor to produce a second voice by changing a feature of the first voice of the user; and
a headphone to play the second voice to the user to influence the first voice of the user.

26. The system of claim 25, wherein the feature is a pitch of the voice.

27. The system of claim 28, wherein the processor is configured to change the pitch of the voice based on data stored a lookup table.

28. The system of claim 26, wherein the processor is configured to change the pitch of the voice to be 5% lower.

29. A device for influencing a user's perception of anxiety, comprising
a holder encompassing a microcontroller and a wireless communication module;
a sensor coupled to the user configured to sense a heart rate of the user; and
a plurality of vibration motors attached to a bottom of the silicone holder, configured to apply a vibration to the user based on the sensed heart rate of the user, wherein the microcontroller is in communication with the plurality of vibration motors to control the vibration based on a signal received by the wireless communication; and
a wrist band, coupled with the silicone holder and the plurality of vibration motors, configured to provide a stable connection between the plurality of vibration motors with the user.

30. The device of claim 29, wherein the vibration is applied to the user at a frequency of 60 bpm.
